(19) United States
(12) Patent Application Publication
(10) Pub. No.: US 2026/0279400 A1
(43) Pub. Date: Sep. 17, 2026

(54) SYSTEMS AND METHODS FOR RESUMING VIDEO RECORDING

(71) Applicant: Adeia Guides Inc., San Jose, CA (US)

(72) Inventors: Toshiro Ozawa, Irvine, CA (US); Tao Chen, Palo Alto, CA (US); Reda Harb, Saint Petersburg, FL (US)

(21) Appl. No.: 19/078,981

(22) Filed: Mar. 13, 2025

(51) Int. Cl. G11B 27/031; G06V 10/75; G06V 20/40; H04N 23/63

(52) U.S. Cl. CPC G11B 27/031; G06V 10/75; G06V 20/46; H04N 23/632

(57) ABSTRACT

Systems and methods for inserting a new video recording of a live scene previewed by a camera into a preexisting video are described. When a detection is made that a camera is previewing a live scene, the system automatically analyzes the live scene, obtains its attributes, and uses them to identify a matching preexisting video, from a plurality of stored preexisting videos. Upon identifying the matching preexisting video, the system automatically identifies a point of insertion in the preexisting video based on one or more factors. The system then downloads specific frames and content surrounding the frames from the matching preexisting video and uses them as references to encode and insert at least a portion of the new video recording of the live scene. Once inserted, the system generates a single continuous video that includes both the matching preexisting video and the new video recording of the live scene.

### FIELD OF DISCLOSURE

Embodiments of the present disclosure relate to identifying a preexisting video, obtaining attributes from the preexisting video, determining similarity of attributes of the preexisting video with attributes of a preview of a live scene, and based at least on the similarity, generating a video recording of the previewed live scene and inserting the video recording at an identified insertion position in the preexisting video to generate a single continuous video that encompasses both the preexisting video and the video recording.

### BACKGROUND

People frequently capture videos with their phones, tablets, and smart watches. The volume and number of recordings have steadily increased with devices capable of storing videos in the cloud rather than being limited to device storage limitations. Since storage is not as much of a limitation anymore, people click away and take many videos of that are similar in footage and depict similar subjects, such as people, places, or pets. For example, a user may record five videos of their pet trying to perform a trick, leading to a collection of redundant clips.

Although video-capturing devices, such as smartphones, have significantly advanced, there remain several drawbacks in current methods that provide room for optimization and refinement. For example, one such drawback is the lack of continuity in current video recording methods. In other words, taking the example of the multiple pet videos described above, there may not be continuity of footage between a first and a second video taken at separate times of the same pet trying to perform a trick. If continuity is to be obtained in this scenario, a user would have to perform manual editing, such as importing the existing footage into a video editor, adding the new recording, synchronizing footage and timing of clips, and then exporting the combined file to create a continuous video recording. This process is time-consuming, cumbersome, and requires video editing skills that many casual users may not have.

Another drawback relates to lack of flexibility in recording. Since a previously recorded video is already saved and stored, using current methods, it cannot be used to resume a recording, unless done so manually using cumbersome processes. This inability to resume recording directly from or within the existing video, unless performed manually, restricts editing options, such as adding other similar footage to the previous video or inserting a new segment in the middle of the previous video thereby leaving the user no choice but to re-record a new video and then perform the manual importing and editing described above.

Even if a current application were to allow a user to resume recording, yet another drawback is that the previous video that has been stored for which the recording is to be resumed has to be manually identified and selected by the user. Since a user may take several videos, searching through the library of previous videos, despite the search capabilities of the device, and locating the desired footage, especially when multiple videos of the same person, location, or pet exist, may be cumbersome and time consuming. It may also not be achievable to do in a short time via manual processing when the user desires to record another video and associate it with the previously recorded video.

As such, there is a need for systems and methods that allow resuming of video recording and its insertion into a preexisting video by optimizing usage of computing resources and providing advanced insertion and integration options.

### BRIEF DESCRIPTION OF THE DRAWINGS

The various objects and advantages of the disclosure will be apparent upon consideration of the following detailed description, taken in conjunction with the accompanying drawings, in which like reference characters refer to like parts throughout, and in which:

FIG. 1 is a block diagram of an exemplary process for resuming recording of a video and inserting/appending the recorded video to a preexisting video, in accordance with some embodiments of the disclosure;

FIG. 2 is a block diagram of an exemplary system for resuming recording of a video and inserting/appending the recorded video to a preexisting video, in accordance with some embodiments of the disclosure;

FIG. 3 is a block diagram of an exemplary user device used for resuming recording of a video and inserting/appending the recorded video to a preexisting video, in accordance with some embodiments of the disclosure;

FIG. 4 is a flowchart of an exemplary process for resuming recording of a video and inserting/appending the recorded video to a preexisting video, in accordance with some embodiments of the disclosure;

FIG. 5 is a flowchart of an exemplary process for resuming recording into a high-resolution version of the preexisting video, in accordance with some embodiments of the disclosure;

FIG. 6 is a flowchart of an exemplary process for downloading frames and content associated with the preexisting video based on its insertion point, in accordance with some embodiments of the disclosure;

FIG. 7 is a flowchart of an exemplary process for downloading frames and content associated with the preexisting video when the insertion point for the resumed video is in the middle of the preexisting video, in accordance with some embodiments of the disclosure;

FIG. 8 is a flowchart of an exemplary process for downloading frames and content associated with the preexisting video when the insertion point for the resumed video is at the end of the preexisting video, in accordance with some embodiments of the disclosure;

FIG. 9 is an example of a block diagram for inserting the resumed video (e.g., the new recording) into the preexisting video, in accordance with some embodiments of the disclosure;

FIG. 10 is a block diagram of an electronic device used for resuming video recording into a preexisting video based on matching characteristics/attributes, in accordance with some embodiments of the disclosure;

FIG. 11 is a block diagram of an electronic device used for resuming video recording, in accordance with some embodiments of the disclosure; and

FIG. 12 is a block diagram of plurality of features relating to inserting and sharing of videos, in accordance with some embodiments of the disclosure.

### DETAILED DESCRIPTION

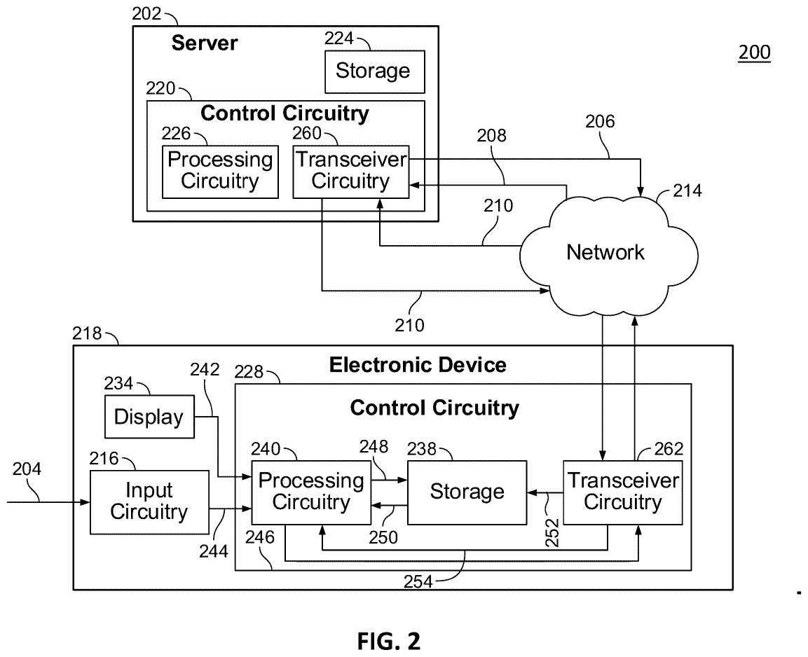

In accordance with some embodiments disclosed herein, some of the above-mentioned limitations are overcome by inserting or appending a newly captured video into a preexisting video to generate a single continuous video file. Some of the above-mentioned limitations are also overcome by detecting that a camera associated with an electronic device is previewing a live scene, which is a scene that is visible to the camera in its line of sight when the camera is turned on, for example, a live scene displayed in a viewfinder of a camera when it's in preview mode but not yet recording the live scene. Based on detecting the live scene in the preview, the camera, control circuitry from FIG. 2, or a server associated with the camera, automatically analyzes the live scene in the preview to obtain one or more attributes of the preview of the live scene. These attributes may relate to the person, object, animal, scene, or action visible in the preview. The attributes may also relate to the camera or the electronic device's setting during the preview, e.g., brightness, resolution, contrast, etc.

In some embodiments, once the one or more attributes of the preview of the live scene are obtained, the system may automatically identify one or more preexisting videos, from a plurality of preexisting videos, that include an attribute that matches, or is similar to, an obtained attribute of the live scene. Such similarity of attributes may be used to identify similar footage between the preexisting video and the live scene in the preview. One such example of shared attributes that relate to similarity in footages may be a same dog playing in the park in the preexisting video and in the live scene in the preview. Another such example of shared attributes that relate to similarity in footages may be a different baseball player performing a same action of throwing a baseball, where the similarity is in the action of throwing the baseball, in the preexisting video and in the live scene in the preview.

In some embodiments, the preexisting videos that are matched may be located or stored on the electronic device itself. In other embodiments, the preexisting videos that are matched may be located in the cloud or at a remote storage location. To identify the matching preexisting videos, the system may use keywords and other terms, images, or voice samples from the preview and perform a query to various databases, including cloud and remote storages, to identify one or more preexisting videos based on a plurality of factors. When more than one preexisting video is identified, the system may filter to narrow it down to select a single preexisting video into which to insert or append the live scene in the preview, either while it is being recorded or after it has been recorded.

The system may also determine an insertion point in the selected preexisting video. The insertion point may be selected based on a plurality of factors to identify the ideal insertion point in the preexisting video. One such factor used, among other factors described herein, may be continuity of scene. When this factor is used, the system may identify an insertion point for the newly recorded video into the preexisting video such that when inserted, scene continuity from the preexisting video into the newly recorded video is maintained. In other words, the insertion allows for a cohesive and contextual continuity of scene from the preexisting video to the newly recorded video, thereby providing an appearance of the same scene being continued.

In some embodiments, the insertion point may be at the beginning, middle, or end of the preexisting video. If the system determines that the insertion point is in the middle of the preexisting video stored on a remote storage (e.g., remote server), the system may optimize the insertion process. As such, instead of downloading the entire preexisting video, the system may download only the specific key frames, such as I-frames or IDR frames, and their surrounding content necessary for the insertion. This approach may minimize processing, resource usage, and bandwidth consumption, as it avoids downloading the entire preexisting video file. By using only a few key frames as reference points, the system may integrate the recoding of the live scene in the preview, when recorded, into the preexisting video. API calls to remote/cloud storage services may be made by the system to download the above-described frames if the preexisting videos are stored either in the cloud or a remote storage.

As part of the process to insert the recoding of the live scene in the preview, when recorded, into the preexisting video, the system may split the preexisting video into two segments, a pre-insertion segment and a post-insertion segment. Although the preexisting video is split into two parts, the pre-insertion segment and a post-insertion segment, the pre-insertion segment and a post-insertion segment are not downloaded in their entirety to the electronic device for inserting the new video (i.e., the resumed video) since doing that would require a large amount of processing and use of memory, thereby burdening the processor.

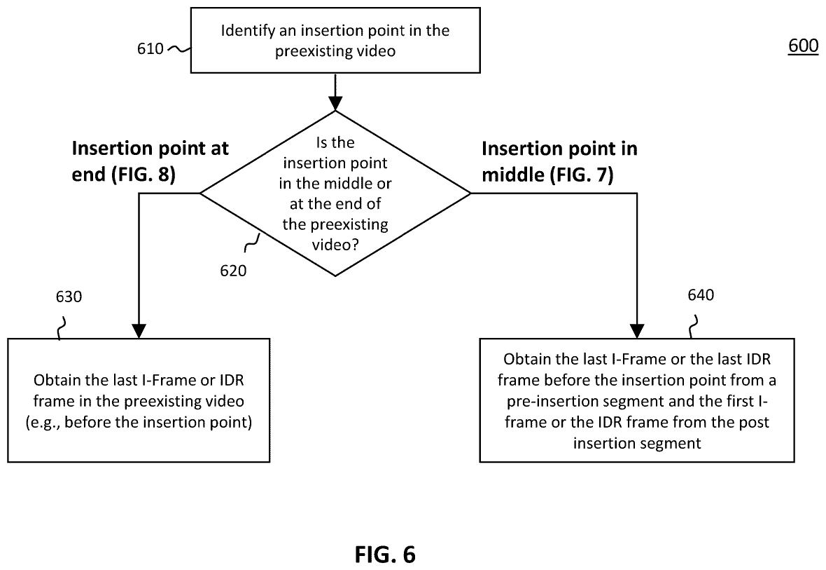

Instead, only key frames before and after the insertion point, which are contextually related, such as same scene, same action that logically continues from one frame to another, and a minimal amount of content from the key frame leading up to the insertion point and from the insertion point to the next key frame are downloaded. In other words, key frames that are related and have the insertion point between the two key frames are downloaded. More specifically, if IDR frames are used as reference, then in one embodiment, the system may download minimal content, which is just the last IDR frame in the pre-insertion segment before the insertion point and the first IDR frame in the post-insertion segment following the insertion point. In another embodiment, if IDR frames are used as reference, the system may download a) content in the pre-insertion segment leading up to the last IDR frame of the pre-insertion segment, b) the last IDR frame in the pre-insertion segment before the insertion point, c) the first IDR frame in the post-insertion segment following the insertion point, and d) content following the IDR frame in the post-insertion segment. If I-frames are used as reference, in one embodiment, the system may download minimal content, which is just the content in the pre-insertion segment that follows the last I-frame up until the insertion point and the content in the post-insertion segment until the first I-frame in the post-insertion segment. In another embodiment, if I-frames are used as reference, the system may download a) the last I-frame in the pre-insertion segment before the insertion point, b) content in the pre-insertion segment that follows the last I-frame up until the insertion point, c) content in the post-insertion segment until the first I-frame in the post-insertion segment and d) the first I-frame in the post-insertion segment. If the insertion point is in the beginning or the end, the new video may be encoded from scratch, and a single I-frame or IDR frame of the preexisting video, as further described in relation to FIGS. 6-8, may be downloaded and used as reference to append the video recording of the preview.

In some embodiments, the system may display a resume recording button on the electronic device's user interface. When activated, the system may resume video recording, also referred to as a new video recording, from the determined insertion point in the preexisting video. Upon inserting the resumed recording, which is the recording of the live scene visible in the preview, the system may automatically generate a continuous video file that includes both the selected preexisting video and the inserted or appended video recording of the live scene.

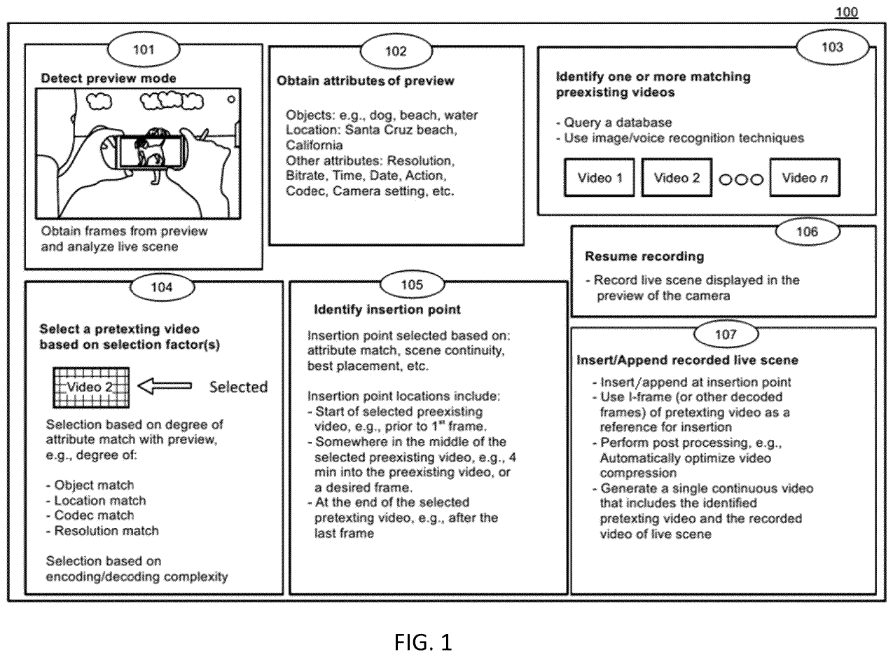

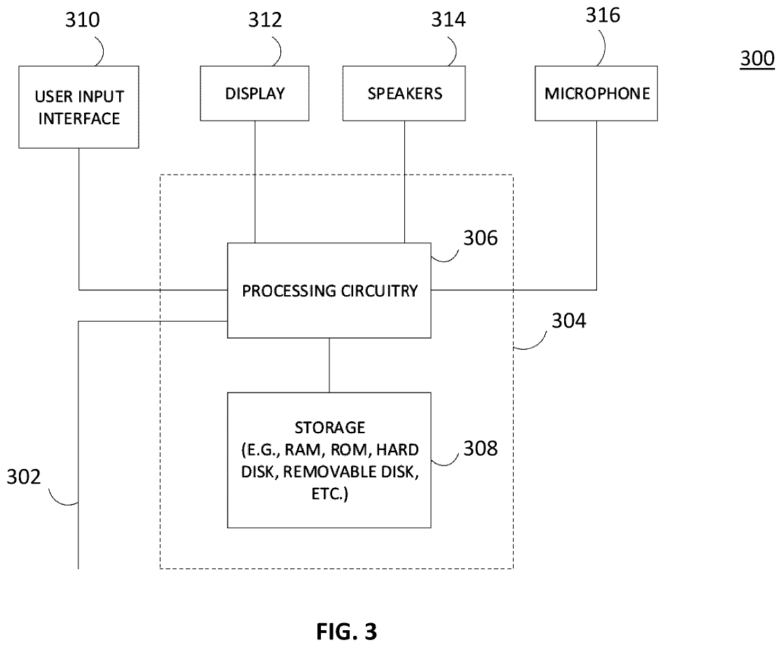

Turning now to the figures, FIG. 1 is a block diagram of an exemplary process for resuming recording of a video and inserting the recorded video to a preexisting video, in accordance with some embodiments of the disclosure. The process 100 may be implemented, in whole or in part, by systems or devices such as those shown in FIGS. 2 and 3. One or more actions of the process 100 may be incorporated into or combined with one or more actions of any other process or embodiments described herein. The process 100 may be saved to a memory or storage (e.g., any one of those depicted in FIGS. 2 and 3) as one or more instructions or routines that may be executed by a corresponding device or system to implement the process 100.

In some embodiments, at block 101, a camera associated with an electronic device detects the device's operational state as being in a preview mode. Such electronic devices may include smartphones, tablets, digital cameras with capability to connect to the internet, smart watches, camcorders with capability to connect to the internet, and any other type of handheld devices that include a camera and are capability of connecting to the internet.

This preview mode is related to a state wherein the electronic device is state-ready to capture still images or video recordings when a user selects or presses a button, such as a picture-taking or recording button that is displayed on a screen of the electronic device or a physical button on certain devices. When in a preview mode, the camera of the electronic device continuously transmits a live video stream to a display on its screen, such as a screen on the smartphone, which may also be referred to herein as a preview screen. This preview screen provides a visual representation of the live scene that may be video recorded by the camera.

In some embodiments, the continuous transmission of the display of the live video stream on the preview screen is automatically analyzed by the electronic device's processor. To perform the analysis, the processor obtains frames from the live scene that is displayed on the preview screen. In other words, the processor obtains frames of the live scene that is visible to the camera based on its line of sight. These are frames from the live scene that is not yet captured or recorded at this stage in a preview. The process may include collecting a plurality of frames from the live scene, buffering the collected plurality of frames from the live scene, and analyzing the buffered plurality of collected frames to determine the attributes. The collected frames from the preview are analyzed to determine the characteristics of current live scene. The analysis of current scene aggregates the information from multiple frames to identify the subject, action, location, date, time of day, person, animal, etc. The analysis of the current scene may also be summarized in a summary by the processor in real time.

The analysis of the current scene may also include detecting other attributes associated with the live scene, such as resolution at which the live scene displayed via the preview is to be captured, codec used to capture the live scene, bitrate, action associated with the scene (such as dog barking, car in motion, etc.), camera settings, etc.

The analysis of the current scene may also include analyzing the audio of the live scene in the preview mode. For example, if a microphone of the electronic device when in preview mode detects an audio input, such as speech, a dog barking, a siren, or other sounds, such audio may also be analyzed, and attributes associated with the audio may be determined.

In some embodiments, at block 102, the attributes of the live scene may be obtained based on the type of analysis performed.

Since continuous movement of the camera may occur due to the user moving constantly with their camera or smartphone being panned in various directions (left, right, up, down) to capture a live scene, the live scene displayed in the preview may also be changed continuously and in real time, sometimes within microseconds, depending on the speed of the user and camera movement.

When such continuous movement occurs, resulting in the preview in the camera also changing rapidly, the attributes associated with the live scene are also changing rapidly and in real time. Obtaining and analyzing changing frames during such rapid movement to determine attributes therefore may require a very complex algorithmic analysis that is performed in some embodiments by the processor. To perform such an analysis of a rapidly changing live scene, in some embodiments, each frame of the live scene in the preview may be processed by the processor during the panning of the camera. In other embodiments, some frames may be skipped by the camera to reduce the amount of processing. Balancing of computational resources may be taken into consideration so as not to overburden the processor. In yet other embodiments, the process may wait until a previous scene is completely out of the preview window to then obtain frames from a new scene and analyze it to obtain the attributes of the new scene. To determine whether the scene is completely out of the preview window, instead of performing a full analysis, the system may perform a partial analysis to save resources and memory, such as by only checking some attributes in the frame until an attribute match no longer exists, which would mean that the scene is out of the preview. The system then may obtain frames from a new scene to then fully analyze them.

For instance, a user in Times Square, New York City, using their smartphone's camera in preview mode, might initially point towards a large screen. As the user pans the camera horizontally or vertically, the preview may be changed due to the panning, with other objects and buildings, like the Marriott Hotel or other parts of Times Square, being brought into the camera's viewfinder. The attributes of each new scene segment are also changed in real time. The scene may be continuously analyzed by the processor, operating dynamically and automatically without user input, as the camera pans, to obtain related attributes of the live scene in real time. In this example, the processor may obtain each sequential frame in the live scene for analysis, it may skip frames and obtain frames after a particular number of skipped frames, or it may obtain frames only after the entire scene is changed, such as if the camera pans out of the large screen at Times Square. These dynamically acquired attributes may subsequently be used to identify matching preexisting videos, as described further below.

At block 103, once attributes of the live scene in the preview window are obtained, the processor may identify one or more matching preexisting videos for which a recording may be resumed and the recording of the live scene, once recorded, may be inserted. As referred to herein, resumed recording relates to a new video recording of content previewed by the camera of a live scene. The attributes, as such, will then be used by the system to compare similar footages (e.g., scenes, frames, similar actions, similar surroundings, same objects or people) or similar segments in footages that have existed in a database, on the electronic device, or in the cloud. In some embodiments, the process of identifying one or more matching preexisting videos may include querying the storage of the electronic device that is used to preview the live scene or querying other remote storage or cloud storage locations, or a combination of both. When querying, the control circuitry may select a keyword that identifies the attribute and then use the keyword to perform the query.

In some embodiments, the matching may be performed to combine similar footages such that a preexisting video of similar footage can be expanded to cover any relevant scenes, anywhere in the footage. To compare or match actions or attributes, the system may leverage CLIP or more sophisticated methods to use on preexisting videos, also referred to as candidate clips, for the resuming of recording. One example of matching footage of a pre-existing video may show a dog attempting, but failing, to catch a frisbee. In this example, when the system, such as the system in FIG. 2, detects in the preview of the camera that the same dog is attempting the same trick, the system may prompt the user to resume recording. The system may display the prompt if the system matches, or is similar to, the same attribute, such as the same dog or park, between the preexisting video and the live scene in the preview. Once recording is resumed for the live scene in the preview, the system may then seamlessly combine the successful frisbee catch from the live recording with the earlier jump attempt from the preexisting video. By doing so, the system may generate an illusion of a single, continuous video where the dog successfully catches the frisbee, even though the footage is from two separate sources (i.e., the preexisting video where the dog jumps and the newly recorded video in which the dog catches the frisbee). Further embodiments related to resuming recording are described below. Additional embodiments relating to resuming recording are described below.

In other embodiments, the matching may be performed to combine footages that share some attribute but are not similar footages. As such, the process of determining a matching preexisting video, or comparing to a preexisting video, may not be constrained to, e.g., exactly a same subject. For example, a recording of baseball actions from multiple players in a same game can be configured to trigger a resuming of recording. Likewise, recording of different soccer players from different teams around the world performing a penalty kick, which may be the common attribute, may also be configured to trigger a resuming of recording.

As depicted at block 103, the system may identify multiple preexisting videos, such as videos Video 1-Video n, that include a matching attribute and either the same or different subjects. At block 104, the system, such as via control circuitry 200 and/or 228 of FIG. 2, may select a preexisting video, from the multiple preexisting videos identified at block 103. When multiple videos are identified that match (or are comparable) to an attribute of the scene in the preview of the camera that is yet to be recorded, the control circuitry 200 and/or 228 applies one or more filtering factors to filter from the identified multiple preexisting videos and select a single preexisting video.

One such filtering factor may include the degree of similarity between the attributes of the multiple preexisting videos and an attribute of the scene in the preview of the camera. For example, if the system is configured to find a degree of similarity of subject and use that as the filtering factor, and all of the multiple preexisting videos include a dog as the attribute common with the preview of the live scene, then the circuitry 200 and/or 228 may determine which dog is more similar to the preview of the live scene. If other dogs are of a different breed and one of the preexisting videos has a dog of the same breed as the preview of the live scene, then the preexisting video with the same breed may be selected based on the degree of similarity of the same breed of dog over other preexisting videos with other dog breeds.

Likewise, if all the multiple preexisting videos include the same dog as the dog in the preview of the live scene, then the control circuitry 200 and/or 228 may select a preexisting video, from the multiple preexisting videos, in which the dog is performing the same trick, or that was shot in the same location, or that has the same background, etc.

Another filtering factor may be complexity of decoding, encoding, and transcoding. For instance, in one embodiment, Video 1 and Video 2 may both be identified as potential candidates for use as a preexisting video since both include an attribute that is common with the attribute of the live scene in the preview. In this scenario, the control circuitry 200 and/or 228 may select a preexisting video, from the multiple preexisting videos Video 1 to Video n, based on complexity of decoding, encoding, and transcoding. Accordingly, the control circuitry 200 and/or 228 may determine which of the two identified preexisting videos is more complex in terms of decoding, encoding, and transcoding to be used for inserting the video to be recoded from the live scene. If a determination is made that Video 1 would be more complex, then the control circuitry 200 and/or 228 may select Video 2 as the preexisting video for use to resume recording the scene displayed in the preview.

Another filtering factor may determine which bitstreams of an existing footage are better suited (e.g., same codec, fewer frames to decode and transcode, matching resolution or frame rate, etc.) for an insertion of new recording. For instance, in one embodiment, Video 1 and Video 2 may both be identified as potential candidates for use as a preexisting video since both include an attribute that is common with the attribute of the live scene in the preview. In this scenario, the control circuitry 200 and/or 228 may select a preexisting video, from the multiple preexisting videos Video 1 and Video 2, based on better-suited footage. If a determination is made that Video 1 is associated with a bitstream that is better suited (e.g., same codec, fewer frames to decode and transcode, matching resolution or frame rate, etc.) than Video 2, then the control circuitry 200 and/or 228 may select Video 1 as the preexisting video for use to resume recording the scene displayed in the preview.

Although a few filtering factors are descried, the embodiments are not so limited, and the system may be configured to use other filtering factors for selecting a preexisting video when multiple preexisting videos match an attribute of the live scene in the preview of the camera. Some examples of other filtering factors may include subject, action, location, resolution, time of day, date, codec, person, animal, and camera settings.

At block 105, the control circuitry 200 and/or 228 may identify an insertion point in the preexisting video selected at block 104. In some embodiments, the insertion point identified may be the best or optimal corresponding position or location in the preexisting video from which the video recording of the scene displayed via the preview may be resumed.

Whether the resumed video recording should be inserted or appended may be determined based on the placement of the insertion point, i.e., whether the insertion point is at the beginning, middle, or end of the selected preexisting video. In terms of frames, whether the resumed video recording should be inserted or appended may be determined based on the whether the insertion point is before the first frame, between the first and last frames, or after the last frame of the pre-existing footage.

The control circuitry 200 and/or 228 may automatically select the insertion point based on any number of factors. In some embodiments, control circuitry 200 and/or 228 may select visual or scene continuity as a factor or as a high priority to select the insertion point. This may be an insertion point where a scene from the preview in the camera that is yet to be recorded may seamlessly extend an existing scene in the preexisting video.

In some embodiments, control circuitry 200 and/or 228 may select narrative, context, or content, as a factor to select the insertion point. The control circuitry 200 and/or 228 may give a high priority to the narrative or context to determine the insertion point. As such, based on a determined narrative of the preexisting video, if the preview in the camera that is yet to be recorded can serve as a prequel or sequel, placement before the start or after the end of the preexisting video may be selected by the control circuitry 200 and/or 228 as an insertion point.

In yet other embodiments, control circuitry 200 and/or 228 may select object matching, location matching, resolution matching, contextual matching, time of day matching, and/or codec matching as a factor(s) to select the insertion point. Accordingly, the control circuitry 200 and/or 228 may give a high priority or weight to object matching, location matching, resolution matching, contextual matching, time of day matching, and codec matching to determine the insertion point.

In some embodiments, the control circuitry 200 and/or 228 may balance between narrative flow, visual continuity, and technical compatibility to determine the insertion point. It may also assign different weights to each factor and evaluate the scene displayed in the preview of the camera to determine the best correlating position in terms of narrative flow, visual continuity, and technical compatibility, or other factors mentioned, to determine the insertion point. Encoding/decoding can impact playback quality and efficiency, and the computational costs of encoding and decoding at various insertion points may also be factors used in selection of the insertion point.

In some embodiments, the control circuitry 200 and/or 228 may obtain guidance from the user or an artificial intelligence (AI) system in determining the insertion point. All the factors mentioned in selection of the insertion point for a selected video may also be used to select between multiple preexisting videos that are to be used for resuming recording.

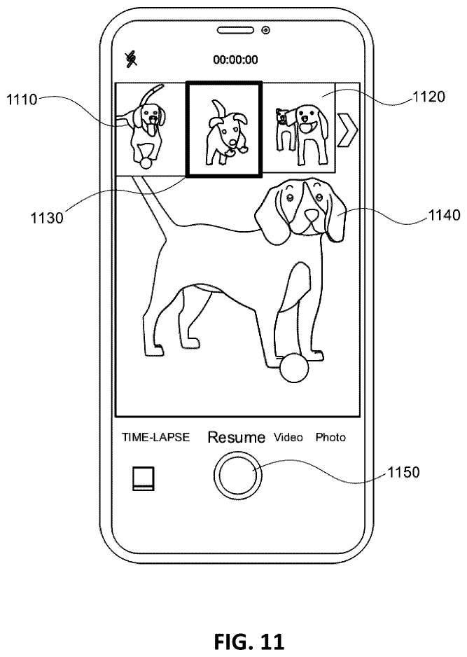

At block 106, the control circuitry 200 and/or 228 may cause an instruction to be provided to the user of the electronic device to resume recording. For example, as depicted in FIG. 11, a resume button 1150 may be displayed on the electronic device's user interface. The trigger to prompt the user to resume recording may be the matching of an attribute between the scene in the preview of the camera and a preexisting video or some other commonality detected between one or more characteristics of the scene in the preview of the camera and a preexisting video. Once the trigger occurs, the control circuitry 200 and/or 228 may prompt the system to display the resume button. An example of a matching attribute or characteristic may be a matching object, location, time, person, action type, etc. For example, while a user is panning the electronic device's camera in a particular direction, if the preview in the camera viewfinder comes across the user's dog performing a trick in their home, the control circuitry 200 and/or 228 may, in real time, obtain frames of the preview, analyze the preview to determine attributes, determine if a matching preexisting video exists that also includes an attribute of the preview (such as the same dog or location or another dog performing the same trick), and if so, identify the insertion point, and then prompt the user to start recording from the insertion point. In this example, the insertion point may be determined at a frame in the preexisting video that has scene, storyline, context, and logical continuity with the preview. Accordingly, the insertion point for a preview video within a pre-existing video may be identified such that any one or more of scene, storyline, context, and logical continuity is maintained. For example, if the pre-existing video shows a dog jumping in the air, and the preview shows the same dog landing, inserting the preview after the frame of the jump maintains continuity because it logically follows that the dog would descend after leaping.

When the depicted resume button is pressed, the electronic device may start recording the preview scene visible in the viewfinder of the electronic device. Once the new video is recorded, i.e., the video of what was visible in the preview of the camera, the control circuitry 200 and/or 228 may determine a plurality of storing options. These options may include storing the resumed recording, i.e., the video recording of the preview in the camera, entirely on the electronic device, entirely in the cloud, or a combination of both, with portions on each. In another embodiment, the control circuitry 200 and/or 228 may store the resumed recording in cloud storage with a download link provided on the electronic device. In some embodiments, the preexisting video may remain on the device while the resumed video recording may be stored in the cloud.

In some embodiments, the resumed recording may be applicable to spatial video. An existing footage, i.e., the preexisting video, and a new recording, i.e., the resumed recording, may both be spatial video. In this scenario, where the preexisting video and the resumed recording are both spatial video, further options may include appending or inserting a resumed recording's left or right view into the preexisting video's 2D footage, with the resumed recording being stored independently. Such an implementation to save both the preexisting video and the new resumed recording may be utilized by the control circuitry 200 and/or 228 to maintain 2D plane consistency between the two footages. The appended or inserted resumed recording may be analyzed by the control circuitry 200 and/or 228 to obtain metadata that may be used for indexing for later use.

In some embodiments, the control circuitry 200 and/or 228 may store low-resolution versions of the resumed recording on the electronic device while full-resolution versions may be stored in the cloud.

Once stored, the resumed recording, along with the preexisting video and their respective metadata, may be accessed. This metadata of the resumed recording may include the timestamp of the recording, camera settings used, location (geotag), object detection and personal identification data, an AI-generated scene summary (keywords describing actions, time, date, etc.), and codec and bitstream parameters like resolution, frame rate, and SDR/HDR.

At block 107, the resumed recording may be inserted or appended to the preexisting video at the identified insertion point. In some embodiments, different approaches may be utilized by the control circuitry 200 and/or 228 depending on where the resumed recording is to be inserted or appended into the preexisting video.

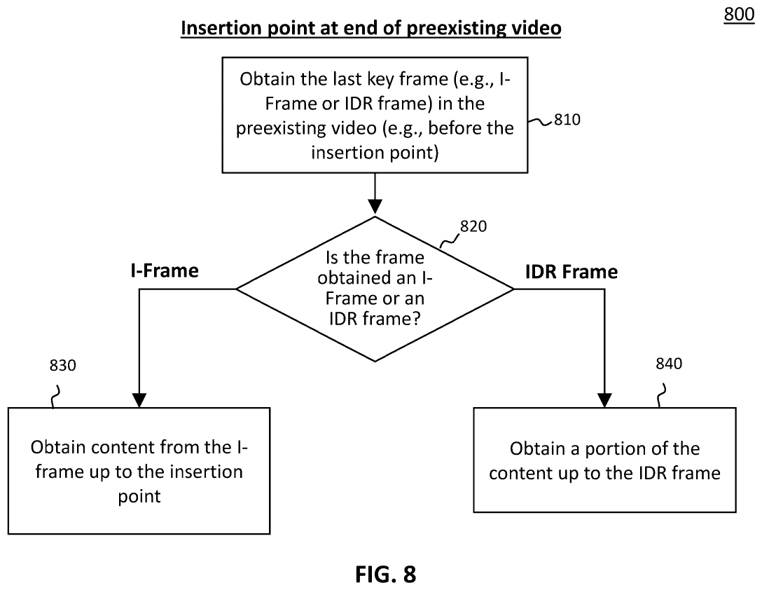

In some embodiments, the insertion point may be at the end of the preexisting video. In other words, the resumed video, i.e., the video of the scene visible via the viewfinder of a camera, after being recorded, or while it is being recorded, is to be appended at the end of the preexisting video. When the resumed video is to be appended at the end of the preexisting video, the appending may be performed efficiently without the need to download the entire preexisting video, which would cause intensive use of resources, computing power, and memory. Instead, the control circuitry 200 and/or 228 may download and re-encode only a small portion of the ending of the preexisting video and use that for reencoding, splicing, and appending the resumed video. Particularly, in this embodiment, the control circuitry 200 and/or 228 may identify the last key frame, such as an I-frame (intra-coded frame) or the last IDR (intra-coded/key) frame, of the preexisting video and use that for reencoding, splicing, and appending the resumed video. Further details relating to merging the resumed video with the preexisting video when the resumed video is to be appended at the end of the preexisting video are described in relation to FIGS. 6 and 8.

In some embodiments, the insertion point may be at the beginning of the preexisting video, e.g., before the first frame of the preexisting video. When the resumed video is to be appended at the beginning of the preexisting video, the appending may be performed efficiently without the need to download the entire preexisting video. If the entire video were to be downloaded, which is not performed in the embodiments, it would use computing resources, computing power, and memory. Therefore, instead, the control circuitry 200 and/or 228 may download and re-encode only a small portion of the beginning of the preexisting video and use that for reencoding, splicing, and appending the resumed video, thereby optimizing the use of computing resources and memory. Particularly, in this embodiment, the control circuitry 200 and/or 228 may identify the first key frame, such as the first I-frame or the first IDR frame of the preexisting video and use that for reencoding, splicing, and appending the resumed video. In some embodiments, when the newly recorded video is a new beginning, e.g., a prequel, which is then to be followed by the preexisting video, the control circuitry 200 and/or 228 may not re-encode any preexisting frames and may just merge the ending of the newly recorded video with the start of the preexisting video. As such, in this embodiment, since the newly recoded video is ahead of the preexisting video, any I-frame or IDR frame of the preexisting video is not used as a reference.

In some embodiments, the insertion point may be in the middle of the preexisting video. In other words, the resumed video, i.e., the video of the scene visible via the viewfinder of a camera, after being recorded, or while it is being recorded, is to be inserted between any two frames of the preexisting video. This may be between two particular scenes, after the opening credits, before the ending credits or anywhere else within the media asset, but not at the very beginning or end. When the resumed video is to be inserted in the middle of the preexisting video, the insertion may be performed efficiently without the need to download the entire preexisting video, which would cause intensive use of resources, computing power, and memory. Instead, the control circuitry 200 and/or 228 may download and re-encode only a small portion of the preexisting video, such as certain key frames and content between the key frames if the insertion point is in the middles, as will be described in further detail below, and use that for reencoding, splicing, and insert the resumed video. In some embodiments, once an insertion point in the preexisting video is identified, the control circuitry 200 and/or 228 may split the preexisting video into two separate video segments. These two separate video segments may be the pre-insertion segment and the post-insertion segment.

In one embodiment, the pre-insertion segment may start from the last IDR (Instantaneous decoding refresh) frame before the insertion point and continues up to the insertion point itself. The post-insertion segment begins immediately after the insertion point and extends to the next IDR frame. IDR frames may be relevant because they are intra-coded frames (I-frames) that contain complete image information, independent of any preceding frames. As such, the IDR frames may prove to be ideal starting points for decoding and using them ensures a smooth transition to insert the resumed recording. When IDR frames are used as references for encoding the resumed recording, content leading up to the last IDR frame before the insertion point in the pre-insertion segment and content following the first IDR frame after the insertion point may be used. In another embodiments, an IDR frame immediately preceding the insertion point and an IDR frame immediately after the insertion point, and content between the two IDR frames may be used. If IDR frames are used as references, then, in one embodiment, the system may download minimal content, which is just the last IDR frame in the pre-insertion segment before the insertion point and the first IDR frame in the post-insertion segment following the insertion point. In another embodiment, using a layering analogy, if IDR frames are used as references, the layer would consist of a) content in the pre-insertion segment leading up to the last IDR frame of the pre-insertion segment, b) the last IDR frame in the pre-insertion segment before the insertion point, c) the first IDR frame in the post-insertion segment following the insertion point, and d) content following the IDR frame in the post-insertion segment. In terms of the amount of content a) and d) download for the insertion, it may be just a single frame or a plurality of frames but not the entire pre-insertion segment or the post-insertion segment.

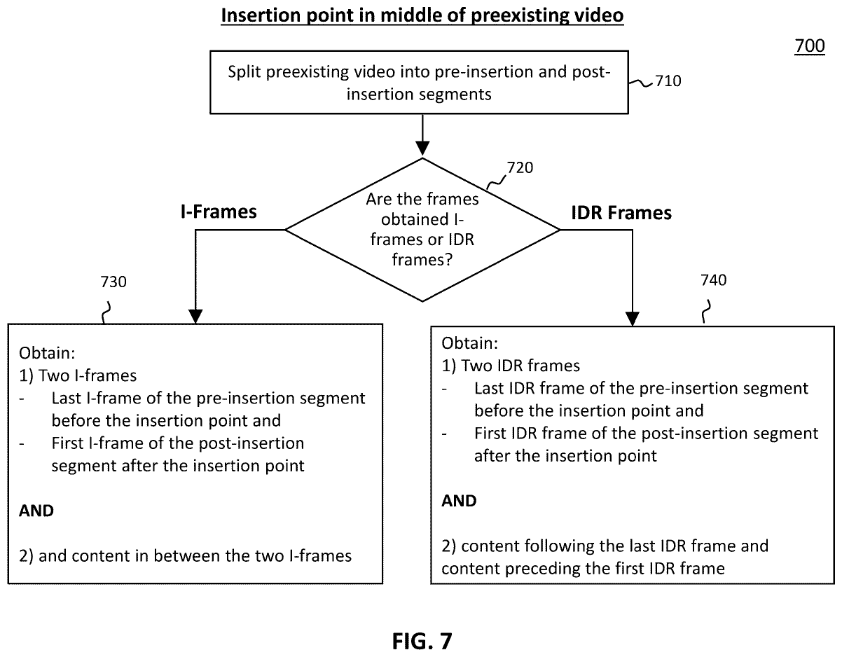

In one embodiment, the pre-insertion segment may start from the last I-frame (intra-frame) before the insertion point and continues up to the insertion point itself. The post-insertion segment begins immediately after the insertion point and extends to the next I-frame, i.e., the first I-frame in the post-insertion segment. The last I-frame in the pre-insertion segment before the insertion point and the first I-frame in the post-insertion segment after the insertion point may be contextually related. For example, they may be a continuation of a same scene, same or similar action, same objects etc. Obtaining I-frames may be relevant because they provide a complete picture, unlike other frame types (e.g., B or P frames) that rely on information from previous frames for decoding. Therefore, using I-frames as boundaries may ensure that the video stream can be correctly decoded after the insertion. In operation, the control circuitry 200 and/or 228 may extract the portion of the pre-insertion segment and the post-insertion segment, i.e., content between two I-frames as well as the I-frames that sandwich the insertion point in the middle. Using such a layered approach may allow the control circuitry 200 and/or 228 to optimize storage by downloading only limited content and I-frames that may be used for reencoding, splicing, and appending. Using a layering analogy, the layers would consist of, in one embodiment, content in the pre-insertion segment that follows the last I-frame up until the insertion point and content in the post-insertion segment until the first I-frame in the post-insertion segment, and, in another embodiment, a) the last I-frame in the pre-insertion segment before the insertion point, b) content in the pre-insertion segment that follows the last I-frame up until the insertion point, c) content in the post-insertion segment that precedes the first I-frame in the post-insertion segment and d) the first I-frame in the post-insertion segment. As such, the resumed recording would then be inserted at the insertion point sandwiched between the two I-frames and the content between them. Further details relating to merging the resumed video with the preexisting video when the resumed video is to be inserted in the middle of the preexisting video are described in relation to FIGS. 6 and 7.

As described above, in some embodiments, either the I-frame or the IDR frame approach may be used by the control circuitry 200 and/or 228 when inserting the resumed video into the middle of the preexisting video. Based on the approach used, different content may be obtained from the pre-insertion segment and the post insertion segment. Since IDR frames are a specific type of I-frame that signals the start of an independent, decodable video sequence, when using IDR frames, content before the last IDR frame before the insertion point in the pre-insertion segment and content after the first IDR frame after the insertion point in the post-insertion segment may be used to allow for decoding and inserting the resumed video. Based on the I-frame approach, the last I-frame before the insertion point in the pre-insertion segment and the first I-frame after the insertion point in the post insertion segment and all content in between the two I-frames may be used to allow for decoding and inserting the resumed video. The last IDR frame in the pre-insertion segment before the insertion point and the first IDR frame in the post-insertion segment after the insertion point may be contextually related. For example, they may be a continuation of a same scene, same or similar action, same objects etc.

Although IDR and I-frames are described above to use as references for encoding, decoding, splicing, and inserting the resumed video, the embodiments are not so limited and the recording and encoding of a resumed video may also start without an IDR or I-frame, e.g., by referencing existing/old frames. Furthermore, any type of key frames may be used.

Additionally, when two key frames are used, where the insertion point is in between the two key frames, then content between the two key frames leading to insertion point may be obtained and used encoding as well.

In some embodiments, the control circuitry 200 and/or 228 may perform the insertion, appending, and merging of the resumed video into the preexisting video on the electronic device itself. In embodiments where insertion, appending, and merging of the resumed video into the preexisting video are performed on the electronic device itself, i.e., when the preexisting video resides on the electronic device itself, there is no need to download the entire pre-existing video, and on-device processing can be performed by using I-frames and IDR frames nearest to the insertion point.

In other embodiments, when a high resolution version of the preexisting video exists in the cloud, the control circuitry 200 and/or 228 may either download certain I-frames or IDR frames of the high resolution version to the electronic device to perform the insertion, appending, and merging of the resumed video or perform the insertion, appending, and merging of the resumed video directly in the cloud.

The process may include determining whether a lower-resolution version of the video exists locally on the electronic device while a higher-resolution version exists in the cloud. If this is the case, the device may automatically avoid capturing and storing the resumed video to the lower-resolution version and instead resume recording to match the high resolution in the cloud version.

In this embodiment, the electronic device used to resume recording, such as a user's smartphone, smartwatch, or tablet, may be aware that preexisting video includes a low resolution version on the device and a high resolution version in the cloud. If a high-resolution version of a preexisting video exists in the cloud, then a resumed recording may be performed such that it can match the same high resolution version (or within a predetermined resolution threshold) of the preexisting video. In this embodiment, the electronic device may maintain a record of preexisting videos and their high resolution versions, such as by ID numbers, metadata, or by saving other identifying information. Such identifying information may also include details relating to the resolution used in the high resolution version of the preexisting video, such as 720p, 1080p, 4K, 8K, etc. When the resumed recording is activated, the electronic device may determine the type of resolution available in the cloud and record the resumed video in the same resolution, if such resolution recording capability is available to the electronic device. For example, if the cloud version is 1080p, then the electronic device may record the resumed video in 1080p. If 1080p capability is not available, then the electronic device may record the resumed video in a resolution closest to 1080p, such as 720p if that is the best resolution and closest to the resolution of the preexisting video allowed by the electronic device. If recorded at the same resolution as the cloud version, the resumed recording may be streamed directly to the cloud and seamlessly appended, merged, or inserted with the preexisting video, maintaining consistent resolution.

The process of downloading certain I-frames or IDR frames of the high resolution version from the cloud to the electronic device to perform the insertion, appending, and merging of the resumed video may include the control circuitry 200 and/or 228 making an API call to retrieve the I-frames or IDR frames such that they can be used as a reference to perform splicing and decoding and seamless integration of the new recorded resumed video with the preexisting video. Which I-frames or IDR frames and content leading up to or in between the frames may also be downloaded may depend on whether the insertion of the resumed video is at the beginning, middle, or end of the preexisting video. As described above, for example, if the insertion of the resumed video is at the end of the preexisting video and I-frames are being used as a reference, then the API call may be made by the control circuitry, such as to the storage location where the preexisting video is stored, to obtain the last I-frame in the pre-insertion segment before the insertion point and content leading up to the insertion point. However, if the insertion point is in the middle, and I-frames are being used as a reference, then an API call may be made by the control circuitry, such as to the storage location where the preexisting video is stored, to download from the cloud to the device, a) the last I-frame in the pre-insertion segment before the insertion point, b) content in the pre-insertion segment that follows the last I-frame up until the insertion point, c) content in the post-insertion segment until the first I-frame in the post-insertion segment and d) the first I-frame in the post-insertion segment. In another embodiment, any two key frames, such as the I-frame or the IDR frames, in between which the insertion point exists, may be downloaded and the content between the two key frames may also be downloaded. In other words, the key frame immediately preceding and following the insertion point and the content between the two frames may be downloaded.

Regardless of whether performing the insertion and merging of the resumed video with the preexisting video on the electronic device or in the cloud, the final merged video may be re-encoded for some existing frames preceding and following the resumed recording to ensure playback compatibility after being merged, especially, as mentioned above, if the resumed video recording's settings, such as resolution or bitrate, differ from those of the preexisting video. In some embodiments, tools such as FFmpeg may be used by the control circuitry to support processing input streams (e.g., RTMP, WebRTC) or video chunks while simultaneously writing to an output. This may allow FFmpeg to process and encode incoming streams from the resumed video in real time without waiting for the entire resumed video stream to complete. Video segments from the resumed video may then be inserted or appended incrementally to the preexisting video. In other embodiments, the control circuitry may use a manifest file (e.g., an .m3u8 playlist) to list all video segments, both existing and new, and dynamically update the playlist as new segments from the resumed video become available.

The process of downloading only selected I-frames, IDR frames, and content leading up to IDR frames or in between I-frames, rather than the entire preexisting video from the cloud to the electronic device used for resuming the recording provides several technical advantages, especially for electronic devices, such as smartphones, that have limited memory and processing resources. Such technical advantages include significantly reducing the amount of data transferred from the cloud and stored on the electronic device. Since I-frames are keyframes that contain the complete image information for a particular frame, unlike other frame types that rely on information from previous frames, by downloading only these I-frames (or IDR frames) and surrounding content, the electronic device may be able to seamlessly integrate the resumed video with the preexisting video without the need for the complete preexisting video, thereby reducing computational processing and substantially saving storage use, freeing up valuable space for other apps, media, or system files. Such technical advantages also include reducing the amount of decoding to be performed. Since decoding a full preexisting video stream may involve complex computations to reconstruct each frame based on predictions from previous ones, by downloading only I-frames (or IDR frames) and surrounding content, the use of computing resources, such as the processor, may be reduced. As such, the processor may only need to decode the downloaded I-frames, which use a simpler and less computationally intensive task than processing the entire video. Such reduction in use of the processor may also lead to lower power consumption and less strain on the hardware, especially when such repeated strain on the battery of the electronic device may reduce its overall battery life. Such technical advantages include saving data costs by consuming lesser bandwidth as opposed to downloading an entire preexisting video, which may be a large file. Such downloading of only I-frames may also lead to faster download times and lower data costs, especially in areas with poor network coverage or expensive data plans.

FIG. 2 is a block diagram of an exemplary system for resuming recording of a video and inserting/appending the recorded video to a preexisting video, in accordance with some embodiments of the disclosure and FIG. 3 is a block diagram of an exemplary user device used for resuming recording of a video and inserting/appending the recorded video to a preexisting video, in accordance with some embodiments of the disclosure. FIGS. 2 and 3 also describe example devices, systems, servers, and related hardware that may be used to implement processes, execute user interface operations, and all other steps, functions and functionalities described at least in relation to FIG. 1, and 4-12. Further, FIGS. 2 and 3 may also be used for detecting that a camera associated with an electronic device is previewing a live scene that is visible to the camera in its line of sight, obtaining one or more attributes of the preview of the live scene, identifying one or more preexisting videos, from a plurality of preexisting videos, that include an attribute that matches with the obtained attribute of the live scene, identifying the preexisting videos that are a match based on querying preexisting videos that are stored either on the electronic device or a remote storage or the cloud, selecting a preexisting video, from the identified one or more preexisting videos based on a plurality of factors, determining an insertion point in the selected preexisting video, determining whether the insertion point is at the beginning, middle, or end of the preexisting video, upon determining that the insertion is in the middle of the preexisting video and that the video is stored either in cloud or remote storage and may be downloaded for performing the insertion or appending, then splitting the preexisting video into two segments, a pre-insertion segment and a post-insertion segment and downloading only certain frames of the preexisting video and more specifically either downloading minimal content, which may be the last IDR frame in the pre-insertion segment before the insertion point and the first IDR frame in the post-insertion segment following the insertion point, or slightly more that minimal content, which may be a) content in the pre-insertion segment leading up to the last IDR frame of the pre-insertion segment, b) the last IDR frame in the pre-insertion segment before the insertion point, c) the first IDR frame in the post-insertion segment following the insertion point, and d) content following the IDR frame in the post-insertion segment or downloading minimal content, which may be content in the pre-insertion segment that follows the last I-frame up until the insertion point and content in the post-insertion segment until the first I-frame in the post-insertion segment, or slightly more that minimal content which may be a) the last I-frame in the pre-insertion segment before the insertion point, b) content in the pre-insertion segment that follows the last I-frame up until the insertion point, c) content in the post-insertion segment until the first I-frame in the post-insertion segment and d) the first I-frame in the post-insertion segment, downloading certain frames as described herein to the device if the insertion is at the beginning or end of the preexisting video, resuming video recording from the determined insertion point to video record the live scene, as needed, making API calls to remote storage and cloud to download the above-described frames if the preexisting videos is stored either in the cloud or a remote storage, inserting or appending the video recording of the live scene at the determined insertion point to generate a continuous video that includes both the selected preexisting video, and the inserted or appended video recording of the live scene, utilizing AI and ML algorithms, and performing functions related to all other processes and features described herein.

In some embodiments, one or more parts of, or the entirety of system 200, may be configured as a system implementing various features, processes, functionalities and components of FIG. 1, and 4-12. Although FIG. 2 shows a certain number of components, in various examples, system 200 may include fewer than the illustrated number of components and/or multiples of one or more of the illustrated number of components.

System 200 is shown to include a computing device 218, a server 202 and a communication network 214. It is understood that while a single instance of a component may be shown and described relative to FIG. 2, additional instances of the component may be employed. For example, server 202 may include, or may be incorporated in, more than one server. Similarly, communication network 214 may include, or may be incorporated in, more than one communication network. Server 202 is shown communicatively coupled to computing device 218 through communication network 214. While not shown in FIG. 2, server 202 may be directly communicatively coupled to computing device 218, for example, in a system absent or bypassing communication network 214.

Communication network 214 may comprise one or more network systems, such as, without limitation, internet, LAN, Wi-Fi or other network systems suitable for audio processing applications. In some embodiments, system 200 excludes server 202, and functionality that would otherwise be implemented by server 202 is instead implemented by other components of system 200, such as one or more components of communication network 214. In other embodiments, server 202 works in conjunction with one or more components of communication network 214 to implement certain functionality described herein in a distributed or cooperative manner. Similarly, in some embodiments, system 200 excludes computing device 218, and functionality that would otherwise be implemented by computing device 218 is instead implemented by other components of system 200, such as one or more components of communication network 214 or server 202, or a combination. In still other embodiments, computing device 218 works in conjunction with one or more components of communication network 214 or server 202 to implement certain functionality described herein in a distributed or cooperative manner.

Computing device 218 includes control circuitry 228, display 234 and input circuitry 216. Control circuitry 228 in turn includes transceiver circuitry 262, storage 238 and processing circuitry 240. In some embodiments, computing device 218 or control circuitry 228 may be configured as electronic device 300 of FIG. 3.

Server 202 includes control circuitry 220 and storage 224. Each of storages 224 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each storage 224, 238 may be used to store various types of content (e.g., preexisting videos, insertions points, attributes and characteristics of preexisting videos and the preview of the live scene, factors for selecting a match between the preexisting videos and the preview of the live scene, downloaded I-frames and IDR frames, download content surrounding the I-frames and IDR frames, electronic device and its camera's settings and capabilities, final video which includes the preexisting video and the resumed video and, AI and ML algorithms). Non-volatile memory may also be used (e.g., to launch a boot-up routine, launch an app, render an app, and carry out other instructions). Cloud-based storage may be used to supplement storages 224, 238 or instead of storages 224, 238. In some embodiments, data relating to preexisting videos, insertions points, attributes and characteristics of preexisting videos and the preview of the live scene, factors for selecting a match between the preexisting videos and the preview of the live scene, downloaded I-frames and IDR frames, download content surrounding the I-frames and IDR frames, electronic device and its camera's settings and capabilities, final video which includes the preexisting video and the resumed video and data relating to all other processes and features described herein, may be recorded and stored in one or more of storages 224, 238.

In some embodiments, control circuitry 220 and/or 228 executes instructions for an application stored in memory (e.g., storage 224 and/or storage 238). Specifically, control circuitry 220 and/or 228 may be instructed by the application to perform the functions discussed herein. In some implementations, any action performed by control circuitry 220 and/or 228 may be based on instructions received from the application. For example, the application may be implemented as software or a set of executable instructions that may be stored in storage 224 and/or 238 and executed by control circuitry 220 and/or 228. In some embodiments, the application may be a client/server application where only a client application resides on computing device 218, and a server application resides on server 202.

The application may be implemented using any suitable architecture. For example, it may be a stand-alone application wholly implemented on computing device 218. In such an approach, instructions for the application are stored locally (e.g., in storage 238), and data for use by the application is downloaded on a periodic basis (e.g., from an out-of-band feed, from an internet resource, or using another suitable approach). Control circuitry 228 may retrieve instructions for the application from storage 238 and process the instructions to perform the functionality described herein. Based on the processed instructions, control circuitry 228 may determine a type of action to perform in response to input received from input circuitry 216 or from communication network 214. For example, in response to detecting a live scene in the preview, the control circuitry 228 may automatically and without user intervention obtain attributes and characteristics associated with the preview and use them to identify one or more preexisting videos that include matching or similar attributes and characteristics. The control circuitry 228 may also perform steps of processes described in FIGS. 1 and 4-9, including inserting or appending the resumed video with the preexisting video to generate a single continuous video file.

In client/server-based embodiments, control circuitry 228 may include communication circuitry suitable for communicating with an application server (e.g., server 202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 214). In another example of a client/server-based application, control circuitry 228 may run a web browser that interprets web pages provided by a remote server (e.g., server 202). For example, the remote server may store the instructions for the application in a storage device. The remote server may process the stored instructions using circuitry (e.g., control circuitry 228) and/or generate displays. Computing device 218 may receive the displays generated by the remote server and may display the content of the displays locally via display 234. This way, the processing of the instructions is performed remotely (e.g., by server 202) while the resulting displays, such as the display windows described elsewhere herein, are provided locally on computing device 218. Computing device 218 may receive inputs from the user via input circuitry 216 and transmit those inputs to the remote server for processing and generating the corresponding displays. Alternatively, computing device 218 may receive inputs from the user via input circuitry 216 and process and display the received inputs locally, by control circuitry 228 and display 234, respectively.

Server 202 and computing device 218 may transmit and receive content and data such as data relating to preexisting videos, insertions points, attributes and characteristics of preexisting videos and the preview of the live scene, factors for selecting a match between the preexisting videos and the preview of the live scene, downloaded I-frames and IDR frames, download content surrounding the I-frames and IDR frames, electronic device and its camera's settings and capabilities, final video which includes the preexisting video and the resumed video. Control circuitry 220, 228 may send and receive commands, requests, and other suitable data through communication network 214 using transceiver circuitry 260, 262, respectively. Control circuitry 220, 228 may communicate directly with each other using transceiver circuits 260, 262, respectively, avoiding communication network 214.

It is understood that computing device 218 is not limited to the embodiments and methods shown and described herein. In nonlimiting examples, computing device 218 may be an electronic device, a personal computer (PC), a laptop computer, a tablet computer, a WebTV box, a personal computer television (PC/TV), a PC media server, a PC media center, a handheld computer, a mobile telephone, a smartphone, or any other device, computing equipment, or wireless device, and/or combination of the same capable of suitably detecting that a camera associated with an electronic device is previewing a live scene that is visible to the camera in its line of sight, obtaining one or more attributes of the preview of the live scene, identifying one or more preexisting videos, from a plurality of preexisting videos, that include an attribute that matches with the obtained attribute of the live scene, identifying the preexisting videos that are a match based on querying preexisting videos that are stored either on the electronic device or a remote storage or the cloud, selecting a preexisting video, from the identified one or more preexisting videos based on a plurality of factors, determining an insertion point in the selected preexisting video, determining whether the insertion point is at the beginning, middle, or end of the preexisting video, upon determining that the insertion is in the middle of the preexisting video and that the video is stored either in cloud or remote storage and may be downloaded for performing the insertion or appending, then splitting the preexisting video into two segments, a pre-insertion segment and a post-insertion segment and downloading only certain frames of the preexisting video and more specifically either downloading minimal content, which may be the last IDR frame in the pre-insertion segment before the insertion point and the first IDR frame in the post-insertion segment following the insertion point, or slightly more that minimal content, which may be a) content in the pre-insertion segment leading up to the last IDR frame of the pre-insertion segment, b) the last IDR frame in the pre-insertion segment before the insertion point, c) the first IDR frame in the post-insertion segment following the insertion point, and d) content following the IDR frame in the post-insertion segment or downloading minimal content, which may be content in the pre-insertion segment that follows the last I-frame up until the insertion point and content in the post-insertion segment until the first I-frame in the post-insertion segment, or slightly more that minimal content which may be a) the last I-frame in the pre-insertion segment before the insertion point, b) content in the pre-insertion segment that follows the last I-frame up until the insertion point, c) content in the post-insertion segment until the first I-frame in the post-insertion segment and d) the first I-frame in the post-insertion segment, downloading certain frames as described herein to the device if the insertion is at the beginning or end of the preexisting video, resuming video recording from the determined insertion point to video record the live scene, as needed, making API calls to remote storage and cloud to download the above-described frames if the preexisting videos is stored either in the cloud or a remote storage, inserting or appending the video recording of the live scene at the determined insertion point to generate a continuous video that includes both the selected preexisting video, and the inserted or appended video recording of the live scene. Control circuitry 220 and/or 228 may be based on any suitable processing circuitry such as processing circuitry 226 and/or 240, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor). In some embodiments, control circuitry 220 and/or control circuitry 228 is configured for allowing the electronic device to perform the operation of detecting that a camera associated with an electronic device is previewing a live scene that is visible to the camera in its line of sight, obtaining one or more attributes of the preview of the live scene, identifying one or more preexisting videos, from a plurality of preexisting videos, that include an attribute that matches with the obtained attribute of the live scene, identifying the preexisting videos that are a match based on querying preexisting videos that are stored either on the electronic device or a remote storage or the cloud, selecting a preexisting video, from the identified one or more preexisting videos based on a plurality of factors, determining an insertion point in the selected preexisting video, determining whether the insertion point is at the beginning, middle, or end of the preexisting video, upon determining that the insertion is in the middle of the preexisting video and that the video is stored either in cloud or remote storage and may be downloaded for performing the insertion or appending, then splitting the preexisting video into two segments, a pre-insertion segment and a post-insertion segment and downloading only certain frames of the preexisting video and more specifically either downloading minimal content, which may be the last IDR frame in the pre-insertion segment before the insertion point and the first IDR frame in the post-insertion segment following the insertion point, or slightly more that minimal content, which may be a) content in the pre-insertion segment leading up to the last IDR frame of the pre-insertion segment, b) the last IDR frame in the pre-insertion segment before the insertion point, c) the first IDR frame in the post-insertion segment following the insertion point, and d) content following the IDR frame in the post-insertion segment or downloading minimal content, which may be content in the pre-insertion segment that follows the last I-frame up until the insertion point and content in the post-insertion segment until the first I-frame in the post-insertion segment, or slightly more that minimal content which may be a) the last I-frame in the pre-insertion segment before the insertion point, b) content in the pre-insertion segment that follows the last I-frame up until the insertion point, c) content in the post-insertion segment until the first I-frame in the post-insertion segment and d) the first I-frame in the post-insertion segment, downloading certain frames as described herein to the device if the insertion is at the beginning or end of the preexisting video, resuming video recording from the determined insertion point to video record the live scene, as needed, making API calls to remote storage and cloud to download the above-described frames if the preexisting videos is stored either in the cloud or a remote storage, inserting or appending the video recording of the live scene at the determined insertion point to generate a continuous video that includes both the selected preexisting video, and the inserted or appended video recording of the live scene, and utilizing AI and ML algorithms for performing any of the steps herein, and performing functions related to all other processes and features described herein.

Computing device 218 receives a user input 204 at input circuitry 216. For example, computing device 218 may receive data relating to detecting that a camera associated with an electronic device is previewing a live scene that is visible to the camera in its line of sight, obtaining one or more attributes of the preview of the live scene, identifying one or more preexisting videos, from a plurality of preexisting videos, that include an attribute that matches with the obtained attribute of the live scene, identifying the preexisting videos that are a match based on querying preexisting videos that are stored either on the electronic device or a remote storage or the cloud, selecting a preexisting video, from the identified one or more preexisting videos based on a plurality of factors, determining an insertion point in the selected preexisting video, determining whether the insertion point is at the beginning, middle, or end of the preexisting video, upon determining that the insertion is in the middle of the preexisting video and that the video is stored either in cloud or remote storage and may be downloaded for performing the insertion or appending, then splitting the preexisting video into two segments, a pre-insertion segment and a post-insertion segment and downloading only certain frames of the preexisting video and more specifically either downloading minimal content, which may be the last IDR frame in the pre-insertion segment before the insertion point and the first IDR frame in the post-insertion segment following the insertion point, or slightly more that minimal content, which may be a) content in the pre-insertion segment leading up to the last IDR frame of the pre-insertion segment, b) the last IDR frame in the pre-insertion segment before the insertion point, c) the first IDR frame in the post-insertion segment following the insertion point, and d) content following the IDR frame in the post-insertion segment or downloading minimal content, which may be content in the pre-insertion segment that follows the last I-frame up until the insertion point and content in the post-insertion segment until the first I-frame in the post-insertion segment, or slightly more that minimal content which may be a) the last I-frame in the pre-insertion segment before the insertion point, b) content in the pre-insertion segment that follows the last I-frame up until the insertion point, c) content in the post-insertion segment until the first I-frame in the post-insertion segment and d) the first I-frame in the post-insertion segment, downloading certain frames as described herein to the device if the insertion is at the beginning or end of the preexisting video, resuming video recording from the determined insertion point to video record the live scene, as needed, making API calls to remote storage and cloud to download the above-described frames if the preexisting videos is stored either in the cloud or a remote storage, inserting or appending the video recording of the live scene at the determined insertion point to generate a continuous video that includes both the selected preexisting video, and the inserted or appended video recording of the live scene.

Transmission of user input 204 to computing device 218 may be accomplished using a wired connection, such as an audio cable, USB cable, ethernet cable or the like attached to a corresponding input port at a local device, or may be accomplished using a wireless connection, such as Bluetooth, Wi-Fi, WiMAX, GSM, UTMS, CDMA, TDMA, 3G, 4G, 4G LTE, 5G, 5G sidelink (5G NRV2X), 6G, or any other suitable wireless transmission protocol. Input circuitry 216 may comprise a physical input port such as a 3.5 mm audio jack, RCA audio jack, USB port, ethernet port, or any other suitable connection for receiving audio over a wired connection or it may comprise a wireless receiver configured to receive data via Bluetooth, Wi-Fi, WiMAX, GSM, UTMS, CDMA, TDMA, 3G, 4G, 4G LTE, or other wireless transmission protocols.

Processing circuitry 240 may receive input 204 from input circuitry 216. Processing circuitry 240 may convert or translate the received user input 204 that may be in the form of voice input into a microphone. In some embodiments, input circuitry 216 performs the translation to digital signals. In some embodiments, processing circuitry 240 (or processing circuitry 226, as the case may be) carries out disclosed processes and methods. For example, processing circuitry 240 or processing circuitry 226 may perform processes as described in FIGS. 1 and 4-9, respectively.

FIG. 3 is a block diagram of an exemplary user device used for resuming recording of a video and inserting/appending the recorded video to a preexisting video, in accordance with some embodiments of the disclosure. In an embodiment, the equipment device 300, is the same equipment device 218 of FIG. 2. The equipment device 300 may receive content and data via input/output (I/O) path 302. The I/O path 302 may provide audio content. The control circuitry 304 may be used to send and receive commands, requests, and other suitable data using the I/O path 302. The I/O path 302 may connect the control circuitry 304 (and specifically the processing circuitry 306) to one or more communications paths or links (e.g., via a network interface), any one or more of which may be wired or wireless in nature. Messages and information described herein as being received by the equipment device 300 may be received via such wired or wireless communications paths. I/O functions may be provided by one or more of these communications paths or intermediary nodes but are shown as a single path in FIG. 3 to avoid overcomplicating the drawing.

The control circuitry 304 may be based on any suitable processing circuitry such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 or i9 processor). In client/server-based embodiments, the control circuitry 304 may include communications circuitry suitable for detecting that a camera associated with an electronic device is previewing a live scene that is visible to the camera in its line of sight, obtaining one or more attributes of the preview of the live scene, identifying one or more preexisting videos, from a plurality of preexisting videos, that include an attribute that matches with the obtained attribute of the live scene, identifying the preexisting videos that are a match based on querying preexisting videos that are stored either on the electronic device or a remote storage or the cloud, selecting a preexisting video, from the identified one or more preexisting videos based on a plurality of factors, determining an insertion point in the selected preexisting video, determining whether the insertion point is at the beginning, middle, or end of the preexisting video, upon determining that the insertion is in the middle of the preexisting video and that the video is stored either in cloud or remote storage and may be downloaded for performing the insertion or appending, then splitting the preexisting video into two segments, a pre-insertion segment and a post-insertion segment and downloading only certain frames of the preexisting video and more specifically either downloading minimal content, which may be the last IDR frame in the pre-insertion segment before the insertion point and the first IDR frame in the post-insertion segment following the insertion point, or slightly more that minimal content, which may be a) content in the pre-insertion segment leading up to the last IDR frame of the pre-insertion segment, b) the last IDR frame in the pre-insertion segment before the insertion point, c) the first IDR frame in the post-insertion segment following the insertion point, and d) content following the IDR frame in the post-insertion segment or downloading minimal content, which may be content in the pre-insertion segment that follows the last I-frame up until the insertion point and content in the post-insertion segment until the first I-frame in the post-insertion segment, or slightly more that minimal content which may be a) the last I-frame in the pre-insertion segment before the insertion point, b) content in the pre-insertion segment that follows the last I-frame up until the insertion point, c) content in the post-insertion segment until the first I-frame in the post-insertion segment and d) the first I-frame in the post-insertion segment, downloading certain frames as described herein to the device if the insertion is at the beginning or end of the preexisting video, resuming video recording from the determined insertion point to video record the live scene, as needed, making API calls to remote storage and cloud to download the above-described frames if the preexisting videos is stored either in the cloud or a remote storage, inserting or appending the video recording of the live scene at the determined insertion point to generate a continuous video that includes both the selected preexisting video, and the inserted or appended video recording of the live scene, utilizing AI and ML algorithms, and performing functions related to all other processes and features described herein.

The instructions for carrying out the above-mentioned functionality may be stored on one or more servers. Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the internet or any other suitable communication networks or paths. In addition, communications circuitry may include circuitry that enables peer-to-peer communication of primary equipment devices, including communication of primary equipment devices in locations remote from each other (described in more detail below).

Memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called a personal video recorder, or PVRs), solid-state devices, quantum-storage devices, gaming consoles, gaming media, or any other suitable fixed or removable storage devices, and/or any combination of the same. The storage 308 may be used to store various types of content, (e.g., preexisting videos, insertions points, attributes and characteristics of preexisting videos and the preview of the live scene, factors for selecting a match between the preexisting videos and the preview of the live scene, downloaded I-frames and IDR frames, download content surrounding the I-frames and IDR frames, electronic device and its camera's settings and capabilities, final video which includes the preexisting video and the resumed video).

Cloud-based storage, described in relation to FIG. 3, may be used to supplement the storage 308 or instead of the storage 308.

The control circuitry 304 may include audio-generating circuitry and tuning circuitry, such as one or more analog tuners, audio-generation circuitry, filters or any other suitable tuning or audio circuits or combinations of such circuits. The control circuitry 304 may also include scaler circuitry for upconverting and down converting content into the preferred output format of the electronic device 300. The control circuitry 304 may also include digital-to-analog converter circuitry and analog-to-digital converter circuitry for converting between digital and analog signals. The tuning and encoding circuitry may be used by the electronic device 300 to receive and to display, to play, or to record content. The circuitry described herein, including, for example, the tuning, audio-generating, encoding, decoding, encrypting, decrypting, scaler, and analog/digital circuitry, may be implemented using software running on one or more general purpose or specialized processors. If the storage 308 is provided as a separate device from the electronic device 300, the tuning and encoding circuitry (including multiple tuners) may be associated with the storage 308.

The user may utter instructions to the control circuitry 304, which are received by the microphone 316. The microphone 316 may be any microphone (or microphones) capable of detecting human speech. The microphone 316 is connected to the processing circuitry 306 to transmit detected voice commands and other speech thereto for processing. In some embodiments, voice assistants (e.g., Siri, Alexa, Google Home and similar such voice assistants) receive and process the voice commands and other speech.

The electronic device 300 may include a user input interface 310. The interface 310 may be any suitable user interface, such as a remote control, mouse, trackball, keypad, keyboard, touchscreen, touchpad, stylus input, joystick, or other user input interfaces. A display 312 may be provided as a stand-alone device or integrated with other elements of the electronic device 300. For example, the display 312 may be a touchscreen or touch-sensitive display. In such circumstances, the interface 310 may be integrated with or combined with the microphone 316. When the interface 310 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. In some embodiments, the interface 310 may be HDTV-capable. In some embodiments, the display 312 may be a 3D display. The speaker (or speakers) 314 may be provided as integrated with other elements of electronic device 300 or may be a stand-alone unit.

The equipment device 300 of FIG. 3 can be implemented in system 200 of FIG. 2 as primary equipment device 202, but any other type of user equipment suitable for allowing communications between two separate user devices for performing the functions related to resuming recording and inserting or appending it to a preexisting video and performing all the functionalities discussed associated with the figures mentioned in this application.

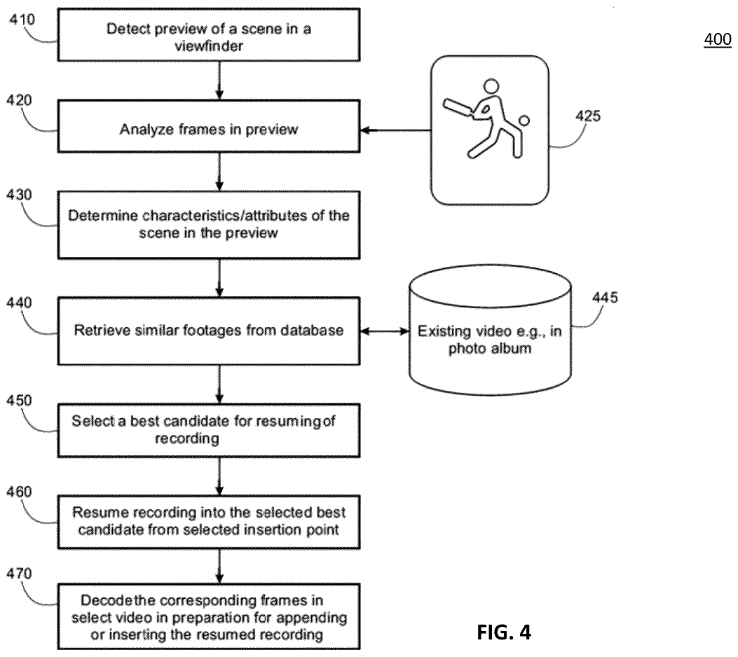

FIG. 4 is a flowchart of an exemplary process 400 for resuming recording of a video and inserting/appending the recorded video to a preexisting video, in accordance with some embodiments of the disclosure. The process 400 may be implemented, in whole or in part, by systems or devices such as those shown in FIGS. 2 and 3. One or more actions of the process 400 may be incorporated into or combined with one or more actions of any other process or embodiments described herein. The process 400 may be saved to a memory or storage (e.g., any one of those depicted in FIGS. 2 and 3) as one or more instructions or routines that may be executed by a corresponding device or system to implement the process 400.

At block 410, in some embodiments, preview of a scene in a viewfinder may be detected. Detecting a scene in the viewfinder relates to the device's camera, such as the smartphone's camera or a tablet's camera, being turned on and being actively engaged in displaying on a screen the real-world environment in real time that the camera's eye can see in its field of vision. This may be a moving image that is a live window to what is visible to the camera in its field of vision. As the user moves the camera (e.g., the electronic device and therefore the camera attached to the electronic device), the camera may pan and adjust to reflect the changing view in its viewfinder, thereby providing a dynamic and interactive experience of the surrounding live scene. When in a preview mode, the camera of the electronic device may continuously transmit a live video stream to a display on its screen, such as a screen on the smartphone, which may also be referred to herein as a preview screen. This preview screen provides a visual representation of the live scene that may be video recorded by the camera. When in a preview mode, the camera of the electronic device may also use its own processor or transmit the scene to a server for the scene to be analyzed.

At block 420, frames in preview of the scene 425 may be analyzed. In some embodiments, the electronic device's processor, or the server, may receive and analyze the live video stream displayed on the preview screen, which is not yet being recorded, by grabbing frames of the live scene visible to the camera. These preview frames may then be analyzed to determine scene characteristics and attributes like subject, action, and location, potentially generating a real-time summary, as depicted at block 430.

At block 440, the control circuitry 200 and/or 228 may retrieve similar footages from a database, such as database 445, which may be stored locally or in the cloud. In some embodiments, similar footage may relate to same objects, locations, people, scenery, etc., where similarity is more literal. For example, similar footage may mean the same dog in a preexisting video(s) is also visible in the viewfinder that is currently panning across a park in which the dog is playing and visible in the line of sight from the camera. In another embodiments, similarity in the similar footage may be more abstract. For example, the preexisting video(s) may show different people, but depict the same type of action, like throwing a baseball or kicking a football. Even if the individuals and specific settings are different, the core activity may the same, making the footage similar. Similarly, footage in the preexisting video(s) and the current preview may be considered similar even if filmed in different locations but sharing some characteristic or attribute, such as a preexisting video of waves in the Pacific Ocean filmed in San Francisco and waves of the Indian Ocean filed in Mumbai, India, since they share the attribute of ocean waves. Similarity may be determined independently by the control system, may be based on guidance from an artificial intelligence system, or may be based on user preferences, e.g., what the user instructs the system to consider as similar.

At block 450, the control circuitry 200 and/or 228 may select the best candidate for resuming recording. In this embodiment, the control circuitry 200 and/or 228 of the system depicted in FIG. 2 may identify multiple preexisting videos that are similar in footage to the live scene in the preview of the camera, i.e., the live scene visible to the camera in its line of sight. For example, a user may have several videos of their dog playing, stored locally or in the cloud, or a golf video of several people and celebrities that the user may find useful in perfecting his/her golf swing. When such multiple similar preexisting videos are detected, the control circuitry 200 and/or 228 may either autonomously, with AI assistance, or through user input, select the most suitable or ideal preexisting video that can be used to insert or append a resumed recording of the preview, e.g., when the preview, which is not being recorded yet, is actually recorded. To select a single preexisting video, the control circuitry 200 and/or 228 may apply any one factor or a combination of filtering factors from the plurality of factors. These factors may include, but are not limited to, subject, person, location, time of recording, degree of similarity between footages, specific action being performed, and even technical considerations like ease of encoding/decoding and splicing. The device's resolution might also be a factor, for example, if the device is capable of recording at 720p resolution, and of the multiple videos identified, only one matches the same 720p resolution, then the control circuitry 200 and/or 228 may select the preexisting video with the 720p resolution for inserting the resumed video to be recorded. In some embodiments, the control circuitry 200 and/or 228 may determine that a higher resolution of preexisting video is available, but the device is not capable of recording the new video, i.e. the scene visible via the preview, at the same higher resolution as the preexisting video. In such a scenario, the control circuitry 200 and/or 228 may apply down sampling to obtain a lower resolution of the preexisting video and then use the lower resolution version when encoding the insertion of the newly recorded video. Although some filtering factors are described here and throughout the document, the embodiments are not so limited, and other filtering factors may also be used to narrow down the selection from multiple similar videos to a single ideal preexisting video. For example, another factor may be audio or sound. For example, if a microphone of the electronic device when in preview mode detects an audio input, such as speech, a dog barking, a siren, or other sounds, such audio may also be analyzed, and attributes associated with the audio may be determined. Such audio attributes may then be matched with preexisting videos to then select a preexisting video that matches the sound from the preview.

Since continuous movement of the camera may occur due to the user moving constantly with their camera or smartphone being panned in various directions (left, right, up, down) to capture a live scene, the live scene displayed in the preview or a sound captured by a microphone may also be changed continuously and in real time, sometimes within microseconds, depending on the speed of the user and camera movement. Accordingly, the preexisting videos that are a match to the preview may also change as the user pans across or moves from one location to another. In some embodiments, a preexisting video that is similar in footage to the preview being displayed may not be a match a microsecond later if the user is panning their camera at a fast pace, such as while driving a car, since new footage may be matched with a different preexisting video. When preview footage changes rapidly, the associated attributes also change rapidly, which may require rapid frame analysis using complex algorithms to identify the attributes and then match them with a preexisting video. For example, a user panning the camera rapidly, such as while running, rotating rapidly, in a moving vehicle, etc., may have in the preview at one instance a city view or a park view and the very next second a completely different scene of an ocean, which would have completely different attributes. To manage this processing load, different strategies may be used by the control circuitry. For example, the control circuitry may skip frames to reduce computational burden and analyze only certain frames and not every frame. Another approach may involve the control circuitry waiting until one scene is completely out of the preview window before processing the next, further optimizing resource usage.

At block 460, the control circuitry 200 and/or 228 may resume recording into the selected best candidate, i.e., the selected preexisting video, and insert or append the resumed video at a selected insertion point of the preexisting video. In some embodiments, resuming recording and inserting or appending the resumed recording, which is the new footage from the preview, into a selected preexisting video involves first determining the insertion point. As mentioned above, this insertion point may be at the beginning, middle, or end of the preexisting video and may be selected based on a plurality of factors, such as continuity of footage or context. Whether the resumed video recording should be inserted or appended may be determined based on the placement of the insertion point, i.e., whether the insertion point is at the beginning, middle, or end of the selected preexisting video. If the insertion point is at the end of the preexisting video, and the preexisting video is stored at a separate storage, such as a remote storage or the cloud, then the control circuitry 200 and/or 228 may download, from the remote storage or the cloud to the device, the last I-frame or the last IDR frame of the preexisting video and use that for decoding, splicing, and encoding the resumed video and appending it to the end of the preexisting video. If an I-frame is downloaded, then content following the I-frame up to the insertion point may also be downloaded. If an IDR frame is downloaded, then content following the IDR frame, such as a few frames, may be downloaded. In another embodiment, any two key frames, such as the I-frame or the IDR frames, in between which the insertion point exists, may be downloaded and the content between the two key frames may also be downloaded. In other words, the key frame immediately preceding and following the insertion point and the content between the two frames may be downloaded.

If the insertion point for the resumed video is in the middle of the preexisting video, and the preexisting video needs to be downloaded, such as from the cloud or remote storage, then the control circuitry 200 and/or 228 may download from the remote storage or the cloud to the device. This process may involve the control circuitry 200 and/or 228 splitting the preexisting video into two separate video segments, the pre-insertion segment, which is before the insertion point, and the post-insertion segment, that is after the insertion point. If IDR frames are to be used as references for insertion of the resumed video, then the control circuitry 200 and/or 228 may download to the device a minimal portion of the preexisting video, which may be just the last IDR frame in the pre-insertion segment before the insertion point and the first IDR frame in the post-insertion segment following the insertion point. If IDR frames are to be used as references for insertion of the resumed video, then, in another embodiment, the control circuitry 200 and/or 228 may download to the device slightly more than the minimal portion, which may be a) content in the pre-insertion segment leading up to the last IDR frame of the pre-insertion segment, b) the last IDR frame in the pre-insertion segment before the insertion point, c) the first IDR frame in the post-insertion segment following the insertion point, and d) content following the IDR frame in the post-insertion segment. In terms of the amount of content a) and d) downloaded for the insertion, it may be just a single frame or a plurality of frames but not the entire pre-insertion segment or the post-insertion segment. If I-frames are to be used as references to insert the resumed video, then the control circuitry 200 and/or 228 may download to the device a minimal portion of the preexisting video, which may be just the content in the pre-insertion segment that follows the last I-frame up until the insertion point and the content in the post-insertion segment until the first I-frame in the post-insertion segment. In another embodiment, the control circuitry 200 and/or 228 may download to the device slightly more that the minimal portion of the preexisting video, which may be a) the last I-frame in the pre-insertion segment before the insertion point, b) content in the pre-insertion segment that follows the last I-frame up until the insertion point, c) content in the post-insertion segment that precedes the first I-frame in the post-insertion segment and d) the first I-frame in the post-insertion segment. As such, the resumed recording would then be inserted at the insertion point sandwiched between the two I-frames and the content between them.

At block 470, post processing, which may include decoding the corresponding frames, such as the I-frames or the IDR frames, whichever are used for references, in preparation for appending or inserting the resumed video. Once decoded, any splicing and encoding may be performed to insert the resumed video at the insertion point into the preexisting video.

After the insertion or appending of the resumed video at the insertion point into the preexisting video, the final merged video may be re-encoded for some existing frames preceding and following the resumed recording to ensure playback compatibility after being merged, especially if the resumed video recording's settings, such as resolution or bitrate, differ from those of the preexisting video. Tools such as FFmpeg may be used by the control circuitry to support processing input streams (e.g., RTMP, WebRTC) or video chunks while simultaneously writing to an output. This may allow FFmpeg to process and encode incoming streams from the resumed video in real time without waiting for the entire resumed video stream to complete.

If the I-frames or IDR frames were downloaded from the remote storage or the cloud, the final merged video may then be uploaded to the remote storage or the cloud, thereby creating a single continuous video that includes both the preexisting video and the resumed video.

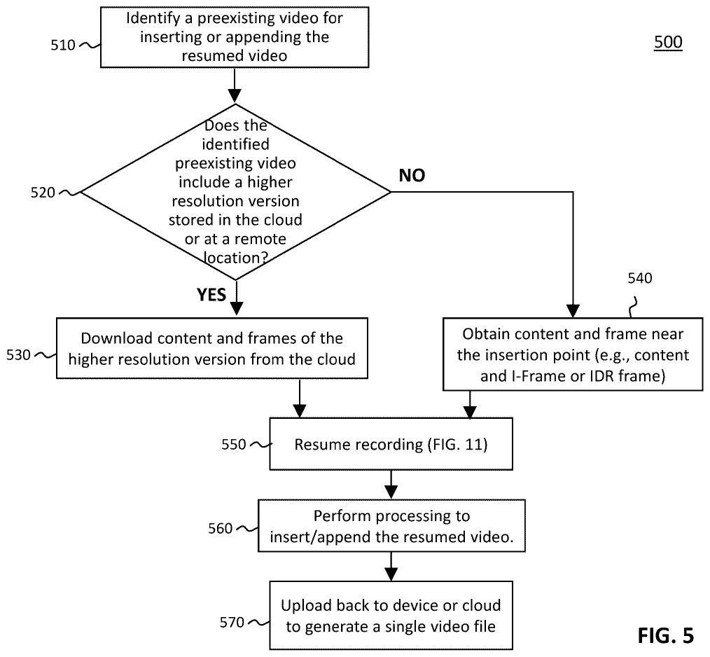

FIG. 5 is a flowchart of an exemplary process 500 for resuming recording into a high resolution version of the preexisting video, in accordance with some embodiments of the disclosure. The process 500 may be implemented, in whole or in part, by systems or devices such as those shown in FIGS. 2 and 3. One or more actions of the process 500 may be incorporated into or combined with one or more actions of any other process or embodiments described herein. The process 500 may be saved to a memory or storage (e.g., any one of those depicted in FIGS. 2 and 3) as one or more instructions or routines that may be executed by a corresponding device or system to implement the process 500.

At block 510, the control circuitry may identify a preexisting video, and an insertion point in the preexisting video at which to insert or append the resumed video. As described above, the preexisting video may be identified based on similarity of footage with the preview of the live scene that is viewable to the camera of the electronic device, but not yet recorded. This may include similarity of characteristics and attributes such as same person, animal, object, location, time, action, etc.

At block 520, the control circuitry may determine whether the identified preexisting video includes a higher resolution version stored in the cloud or at another remote storage location. If a determination is made that a higher resolution version does exist, then the process may move to block 530, where the control circuitry may download content and frames of the high resolution version from the cloud or the remote storage for using as reference to insert or append the resumed video. To minimize the amount of processing and memory reusage, as described above, the control circuitry may only download certain I-frames or IDR frames, and content surrounding the I-frames or the IDR frames. The content and frames obtained may depend on whether the resumed video is to be inserted at the beginning, middle, or end of the preexisting video. Additional details relating to the I-frames and IDR frames that may be downloaded are described in relation to FIGS. 6-8.

If a determination is made at block 520 that the identified pre-existing video does not include a higher resolution version, then the process may move to block 540, where the control circuitry may obtain content and frames near the insertion point to use as reference for inserting the resumed video. These frames may be I-frames or IDR frames. As described above, the content and frames obtained may depend on whether the resumed video is to be inserted at the beginning, middle, or end of the preexisting video. Additional details relating to the I-frames and IDR frames that may be downloaded are described in relation to FIGS. 6-8.

Once the reference frames are obtained along with the content surrounding the frames, then, at block 550, the control circuitry may resume recording of the live scene that is visible via the camera in the preview. In some embodiments, the control circuitry may display a “Resume” recording button on the user interface of the electronic device, as displayed in FIG. 11. The control circuitry may also prompt the user to press the resume recording button such that the preview may be recorded and used for insertion into the preexisting video.

At block 560, the control circuitry may perform processing to insert or append the resumed video at the insertion point in the preexisting video. This process may involve decoding frames of the preexisting video near the insertion point, performing splicing operations, and then encoding frames in order to insert in the resumed video into the insertion point of the preexisting video.

At block 570, once the resumed video is inserted into the pre-existing video, the resulting video may be uploaded to the device or cloud to generate a single video file. This single video file may include the preexisting video and the resumed video inserted at a specific location within the preexisting video, i.e., at the insertion point, in a seamless manner to provide the appearance when played of a single and continuous video file.

FIG. 6 is a flowchart of an exemplary process 600 for downloading frames and content associated with the preexisting video based on its insertion point, in accordance with some embodiments of the disclosure. The process 600 may be implemented, in whole or in part, by systems or devices such as those shown in FIGS. 2 and 3. One or more actions of the process 600 may be incorporated into or combined with one or more actions of any other process or embodiments described herein. The process 600 may be saved to a memory or storage (e.g., any one of those depicted in FIGS. 2 and 3) as one or more instructions or routines that may be executed by a corresponding device or system to implement the process 600.

In some embodiments, at block 610, the control circuitry may identify an insertion point in the pre-existing video. The insertion point may be a point where the preview of a live scene may be recorded and inserted into the pre-existing video.

At block 620, a determination may be made whether the insertion point is in the middle or at the end of the preexisting video. If a determination is made that the insertion point is in the middle of the pre-existing video, then the process may move to block 640, as further described in relation to FIG. 7. If a determination is made that the insertion point is at the start of the preexisting video (not shown in figures) then the encoding of the new video may be done from scratch.

Referring to FIG. 7, in some embodiments, once an insertion point in the preexisting video is identified, the control circuitry 200 and/or 228 may split the preexisting video into two separate video segments., as depicted at block 710. These two separate video segments may be the pre-insertion segment and the post-insertion segment. The pre-insertion segment may be the segment of the preexisting video before and leading up to the insertion point, in other words, the segment from the beginning of the preexisting video and leading up to the insertion point. The post-insertion segment of the preexisting video may be the segment after and following the insertion point to the end of the preexisting video.

At block 720 of FIG. 7, a determination may be made whether the frames obtained are I-frames or IDR frames to be used as a reference or anchor points for inserting the resumed video. If the frames obtained are IDR frames, then the control circuitry 200 and/or 228, at block 740, may obtain or download minimal content, such as the last IDR frame in the pre-insertion segment before the insertion point and the first IDR frame in the post-insertion segment following the insertion point. In another embodiment, if the frames obtained are IDR frames, then the control circuitry 200 and/or 228, at block 740, may obtain or download slightly more that the minimal content, such as a) content in the pre-insertion segment leading up to the last IDR frame of the pre-insertion segment, b) the last IDR frame in the pre-insertion segment before the insertion point, c) the first IDR frame in the post-insertion segment following the insertion point, and d) content following the IDR frame in the post-insertion segment. In terms of the amount of content a) and d) downloaded for the insertion, it may be just a single frame or a plurality of frames but not the entire pre-insertion segment or the post-insertion segment. If the frames obtained are I-frames, then the control circuitry 200 and/or 228, at block 730, may obtain or download minimal content, such as the content in the pre-insertion segment that follows the last I-frame up until the insertion point and content in the post-insertion segment until the first I-frame in the post-insertion segment. In another embodiment, if the frames obtained are IDR frames, then the control circuitry 200 and/or 228, at block 740, may obtain or download slightly more that the minimal content, such as a) the last I-frame in the pre-insertion segment before the insertion point, b) content in the pre-insertion segment that follows the last I-frame up until the insertion point, c) content in the post-insertion segment until the first I-frame in the post-insertion segment and d) the first I-frame in the post-insertion segment. As such, the resumed recording would then be inserted at the insertion point sandwiched between the two I-frames.

Referring back to block 620, if a determination is made that the insertion point is at the end of the preexisting video, then the process may move to block 630, as further described in relation to FIG. 8. If a determination is made that the insertion point is at the start of the preexisting video (not shown in figures) then the encoding of the new video may be done from scratch.

FIG. 8 is a flowchart of an exemplary process for downloading frames and content associated with the preexisting video when the insertion point for the resumed video is at the end of the preexisting video, in accordance with some embodiments of the disclosure. In this embodiment, the insertion of the new video, which is the video in the preview of the camera, may be at the end of the preexisting video. In other words, the insertion may be after the last frame of the preexisting video. In such a scenario, the control circuitry may obtain the last key frame in the pre-existing video before the insertion point, as depicted at block 810. This key frame may be an I-frame or an IDR frame.

At block 820 the control circuitry may determine whether the last keyframe obtained is an I-frame or an IDR frame. If a determination is made at block 820 that the last frame obtained is an I-frame, then at block 830 the control circuitry may obtain content from the I-frame up to the insertion point. In another embodiment if a determination is made that the last frame obtained is the IDR frame, then the control circuitry at block 840 may a portion of the content up to the IDR frame. The portion that is obtained up to the IDR frame may be a minimal portion such as a predetermined number of frames such as not to overburden the device or the system for encoding and processing a large number of frames.

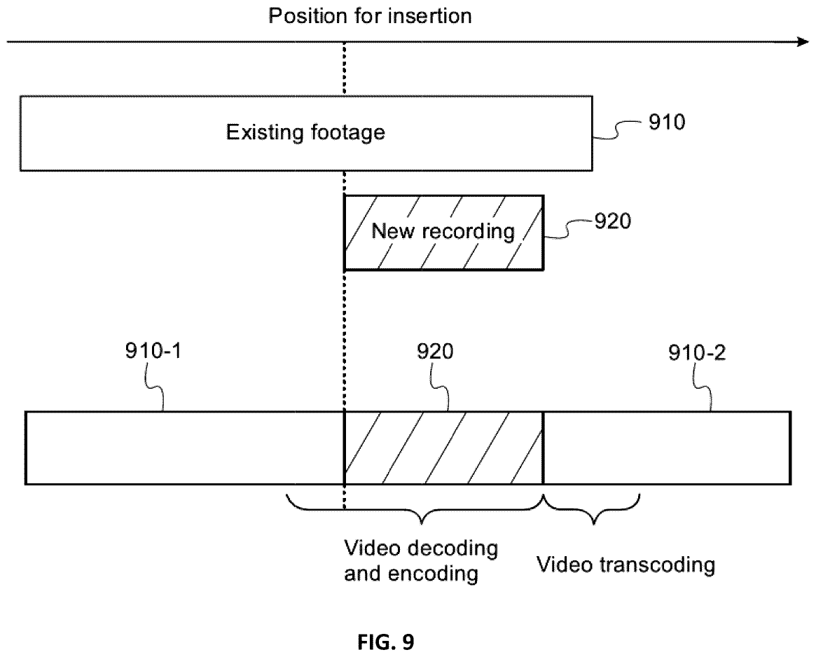

FIG. 9 is an example of a block diagram for inserting the resumed video (i.e., the new recording) into the preexisting video, in accordance with some embodiments of the disclosure.

In some embodiments, the control circuitry 200 and/or 228 may identify one or more preexisting videos that match the preview displayed in a preview window, such as the preview shown on display screen 1140 in FIG. 11. Such a matching may be based on shared characteristics of the preexisting videos with the live scene in the preview. If more than one preexisting video is identified, the control circuitry 200 and/or 228 either automatically without user intervention, or based on user input, may select a single preexisting video, referred to in this figure as “existing footage,” into which to insert the resumed recording.

This existing footage 910 may represent the entire preexisting video. Upon determining that a new recording 920, which is the resumed recording related to what is shown in the preview, is to be inserted at the insertion point of the selected preexisting video, which in this example is in the middle of the existing footage 910, the control circuitry 200 and/or 228 may split the existing footage into two segments: a pre-insertion segment 910-1 and a post-insertion segment 910-2. When the user resumes recording, such as by pressing the “Resume” recording button 1150 in FIG. 11, the new recording 920 may be inserted by the control circuitry 200 and/or 228, or a server, between these two segments. As previously described, the type of frames used (e.g., I-frames or IDR frames) and the content surrounding the frames may be used as references to integrate the new recorded resumed video 920. Additional details relating to specific frames and surrounding content obtained when the resumed recording is inserted in the middle are described above in relation to FIG. 7.

In some embodiments, after inserting the resumed recording between the pre-and post-insertion segments, post processing, such as video decoding, encoding, and transcoding, may be performed by the control circuitry 200 and/or 228, or a user, to seamlessly integrate the new recording in the middle of the preexisting video. Once such post processing is completed, a single video file with continuous playback: pre-insertion segment, followed by the new recording, and then the post-insertion segment may be generated. When the user plays this modified video, the video may play from beginning to end, with the resumed recording in the middle, as if it were a single continuous recording.

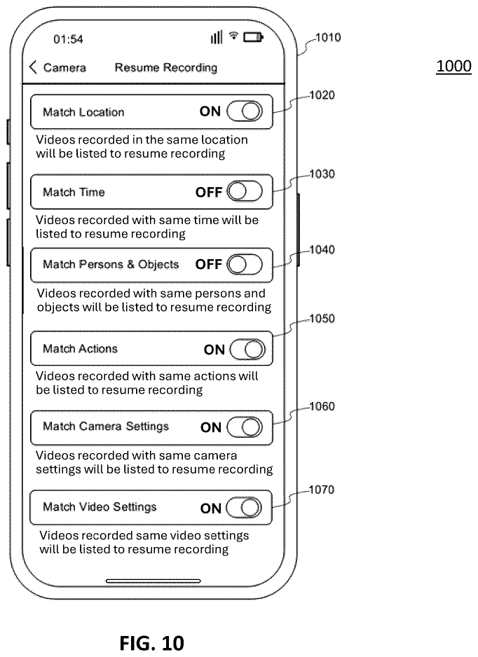

FIG. 10 is a block diagram of an electronic device used for resuming video recording, in accordance with some embodiments of the disclosure. In some embodiments, the control circuitry 200 and/or 228 may determine similarity of footage in the preview, i.e., the live scene within the line of sight of a camera that is visible in the viewfinder associated with a camera, and a preexisting video.

In one embodiment, similarity of footage between the live preview and preexisting video may be literal, relating to the same objects, locations, people, animals, camera settings, or scenery. These factors, used to determine a match between the preview (the resumed video) and the preexisting video may include subject, person, location, recording time, degree of similarity, the specific action, and technical considerations like encoding/decoding and splicing ease. For example, similar footage may be determined by the control circuitry 200 and/or 228 if the same dog appears in both a preexisting video and the current live preview as the camera pans across a park.

In another embodiment, similarity may be more abstract. In this embodiment, preexisting video might show different individuals but depict the same type of action, such as throwing a baseball or kicking a football. Even with different individuals, animals, locations, and settings, the shared core activity, which may be the common attribute, may make the footage be determined to be similar.

In some embodiments, the control circuitry 200 and/or 228 may allow users to select criteria for matching the live scene preview with a preexisting video, e.g., which criteria, characteristics, or attributes to consider determining a match or similar footage. In these embodiments, selectable options may be displayed on the user interface of the recording device, such as the smartphone. These selectable options may include matching location, time, persons and objects, actions, camera settings, and video settings.

Regarding matching location 1020 of FIG. 10, as the user pans across a live scene, the control circuitry 200 and/or 228 may obtain attributes from the preview, including location. If the user activates the “Match Location” option 1020, then location may be used as a factor for identifying matching preexisting videos. For example, if the preview shows the Golden Gate Bridge in San Francisco, and matching by location is turned on, then preexisting videos that are also at or nearby the Golden Gate Bridge may be determined to be a match and be used for inserting the preview when it is recorded. As depicted at 1020, since the option to match location is turned ON, the control circuitry 200 and/or 228 may use the selected option for filtering and automatically display preexisting videos that were recorded in the same location, or withing a predetermined distance of the same location, for selection to resume recording.

Similarly, activating “Match Time” 1030 in FIG. 10, or “Match Persons and Objects” 1040 may be used as a factor, if turned on by the user, to identify preexisting videos matching the preview's time, persons, or objects. As depicted at 1030 and 1040, since the option to match time is turned OFF, the control circuitry 200 and/or 228 may not use match time or Match Persons and Objects as a filtering criterion for displaying preexisting videos that were recorded at the same time, or withing a predetermined time of the current preview, or have matching persons and objects for resuming recording. Although the filtering may not be performed using the turned off option, preexisting videos that include matching persons and object may still be provided to the user based on their match with the preview based on another turned ON criteria, such as Match Actions.

In some embodiments, as described above, similarity of footage may be based on abstract factors in which not the same person, animal, object, or location is present. A factor that may be more abstract may be matching action. If “Match Actions” 1050 is selected as a factor for determining similarity of footage between the preview and the existing video, then the control circuitry 200 and/or 228 may identify preexisting videos that have the same or similar actions as those visible via the preview, regardless of differences in objects or location. For example, a live preview of someone throwing a baseball or a dog jumping would match a preexisting video of a different person throwing a baseball or a different dog jumping. Such a preexisting video may be determined by the control circuitry 200 and/or 228 to be a match for inserting or appending the preview when recorded. As depicted at 1050, since the option to match actions is turned ON, the control circuitry 200 and/or 228 use the selected option for filtering and may automatically display preexisting videos that were recorded with the same action, or a similar for selection to resume recording.

In yet other embodiments, matching camera settings 1060 or video settings 1070 may be other user-selectable options displayed on the user interface by the control circuitry 200 and/or 228. If those options are turned on by the user, the control circuitry 200 and/or 228 may search for preexisting videos with the same or similar camera settings or video settings as those used for the live preview. As depicted at 1060 and 1070, since the option to match camera settings and video settings is turned ON, the control circuitry 200 and/or 228 may automatically display preexisting videos that were recorded in the same or similar camera settings and video settings location for selection to resume recording. Although a few factors for matching attributes and characteristics are displayed from 1020-1070 in FIG. 10 on electronic device 1010's user interface, the matching attributes and characteristics are not limited, and the user may be provided an option to configure their own matching attributes and characteristics as desired. The user may enter any combination of filtering criteria by turning ON or OFF any of the options 1020-1070 and the control circuitry may use the selected option as a filtering criterion for displaying preexisting videos that were recorded.

FIG. 11 is a block diagram of an electronic device used for resuming video recording to be inserted into a preexisting video based on matching characteristics/attributes, in accordance with some embodiments of the disclosure. In this embodiment, any electronic device 1100 that is capable of displaying a real-time preview of a live scene visible to its camera may be used. The system may then use the camera's image, i.e., the preview of live scene visible to the camera in its line of sight, and display it on a user interface on its main screen, such as the screen 1140 of FIG. 11. Although a particular depiction is provided for the main screen to show the preview, the preview may also be displayed in other manner such as in a split-screen fashion, in the top half of the user interface, or having the screen divided into multiple sections with the main screen being larger than other sections that provide display of the preexisting videos.

As described above, when an attribute or characteristic of what is being displayed in the preview window of the live scene matches, either literally or in abstract, one of the preexisting videos that are stored locally on the electronic device or at a remote location or in the cloud, the control circuitry may automatically obtain that preexisting video and display it on the user interface of the electronic device 1100. In some embodiments, the control circuitry 200 and/or 228 may have found multiple preexisting videos that match one or more attributes and characteristics of what is displayed in the preview window. For example, if the user is currently viewing their dog in the park, i.e., through the viewfinder, the control circuitry 200 and/or 228 may suggest preexisting videos of the same dog in the same park.

Once preexisting videos are identified, the control circuitry 200 and/or 228 may cause the display of the multiple matching preexisting videos on the display screen 1140, which is also the preview scene, such as those depicted at 1110-1130. The display of the multiple matching preexisting videos may be at the top of the screen, bottom of the screen, on the sides of the screen, as a pop-up, or some other format. It may also be shown on a separate tab or a separate device. To ensure visual and contextual continuity, these preexisting videos may not just show the starting frame of the preexisting video but show a still image from a point within the preexisting video that closely matches the current viewfinder view 1140. This point represents a suggested insertion point, allowing the new recording, i.e., the recording of what is shown in the preview if it is recorded, to seamlessly continue from that moment in the preexisting video such that scene, context, or image continuity is maintained. For instance, if the preexisting video shows the dog about to pick up a ball, and the live preview shows the same, the still image might show that precise moment, creating a smooth transition when the new recording is inserted. In other embodiments, any still image or a looping video from the preexisting videos may be shown in the sections 1110-1130.

The control circuitry 200 and/or 228 may also display, on the user interface, a resume recording button 1150. This button may allow the user to resume recording, i.e., start recording of what is shown in the preview window, which will then be used to insert or append into the preexisting video. This “resume” feature may be presented such that it is distinct from regular video recording, giving users the option to use it or not.

In some embodiments, the main screen 1140 of the user interface may be used to display a real-time preview, or viewfinder, of the camera's current view. Above this preview window, smaller windows may be used to display still images or looping video clips representing the preexisting videos for resuming recording.

One of these candidate videos may be highlighted as a top recommendation by the control circuitry 200 and/or 228. The top recommendation may be based on the control circuitry 200 and/or 228 receiving recommendations from an AI engine. The recommendations may also be based on factors like the degree of match. The user may also manually select from one of the preexisting videos displayed in 1110-1130.

In some embodiments, the control circuitry 200 and/or 228 may use a color-coding scheme to visually rank the recommendations, with the top recommendation being most prominent. For example, the top recommendation may be outlined in red or green or be highlighted more boldly than others. In other embodiments, the control circuitry 200 and/or 228 may provide a ranking order for the recommendations and display the ranking order on the preview windows 1110-1130.

In yet other embodiments, the control circuitry 200 and/or 228 may provide a preview of what the merged video would look like before the recording is actually resumed. Such preview may allow the user to visualize the final result and select from the multiple preexisting videos. To do this, the control circuitry 200 and/or 228 may utilize any one of a plurality of applications, such Live Photo, e.g., in which there may be frames/content (e.g., a few seconds) to be recorded or saved before the user presses “Resume” 1150.

Once the user selects the resumed recording and the preexisting video, if not automatically elected by the control circuitry 200 and/or 228, the control circuitry 200 and/or 228 causes resuming of the recording and automatically inserts the live preview into the preexisting video at the determined insertion point. The control circuitry 200 and/or 228 may then perform post processing, such as encoding, to generate a single video containing both the preexisting video and what was recorded from the preview window.

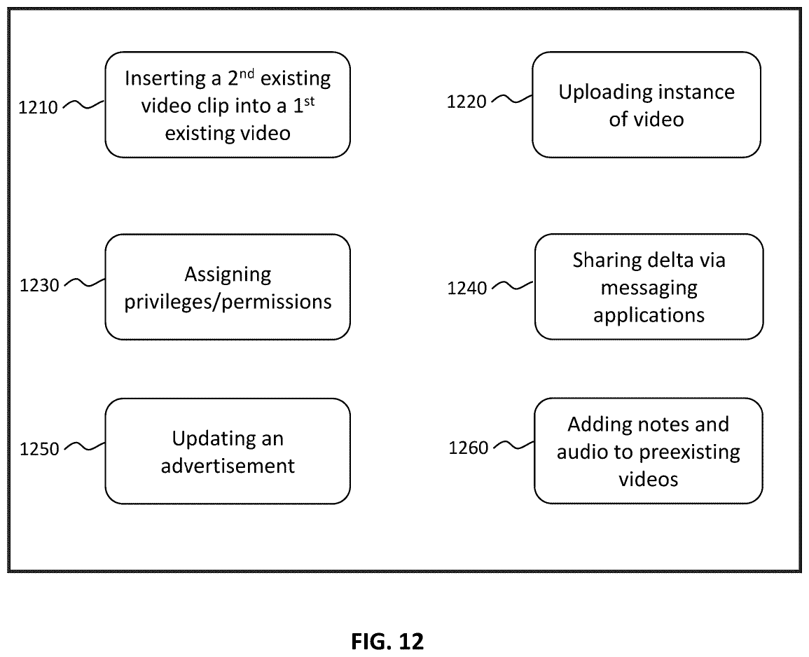

FIG. 12 is a block diagram of plurality of features relating to inserting and sharing of videos, in accordance with some embodiments of the disclosure.

In some embodiments, as depicted at 1210, a second existing video clip may be inserted or appended into a first existing video. Instead of inserting a preview of a live scene, the control circuitry 200 and/or 228 may can insert or append one preexisting video clip into another. In this embodiment, a user may be able to select one or more videos to be inserted into a selected primary video. The control circuitry 200 and/or 228 may then automatically determine the insertion point based on factors such as contextually, logical, visual, auditory similarities and similarities of other attributes. The control circuitry 200 and/or 228 may also determine factors such as scene continuity. In another embodiment, the control circuitry 200 and/or 228, such as based on suggestions from an AI engine, may identify two or more clips that may be combined, or a plurality of clips that may be inserted into an existing primary video clip. The control circuitry 200 and/or 228 may then provide the suggestions to the user for approval prior to performing the insertion(s).

In some embodiments, the control circuitry 200 and/or 228 may suggest a second video, or a portion of the second video, to be inserted into a first video based on contextual similarity. For example, if both videos contain a scene of a dog playing in a park, the control circuitry 200 and/or 228 may suggest inserting the second video clip in the first video clip at an insertion point where corresponding scenes can be played back-to-back.

In some embodiments, only a portion of the second video may be inserted into the first video. If, for instance, the first video is a movie with action, romance, and suspense scenes, and the second video contains a similar action sequence, the control circuitry 200 and/or 228 may identify this contextual match and suggest inserting the action clip from the second video into the first video at an insertion point in the first video where the action scene takes place.

In some embodiments, insertion of one existing video into another existing video may be performed not only to full videos but also to smaller clips within them. When inserting the full videos or smaller portions or clips of the videos, similar merging determinations, as previously described in relation to inserting or appending a preview of a live scene, may be applied. Such determinations may include determining whether the second video or clip should be inserted at the beginning, middle, or end of the first video and accordingly obtaining relevant I-frames or IDR frames to combine them into a single video clip that merges both videos.

In some embodiments, as depicted at 1220, the control circuitry 200 and/or 228 may upload a video to a social media service. In this embodiment, when a user uploads a video to a social media service like Instagram or Facebook, a specific instance of that video may be created on that platform. This instance may be a separate, independent version of the video tied to that particular platform. As such, even if the original video file is stored on the user's phone, in the cloud, or in a remote storage, each social media site, such as Facebook or Instagram, where the video is uploaded may have its own distinct instance. Accordingly, the same video, in some embodiments, may be uploaded as one first instance on Facebook; a different instance, such as a second instance, on Instagram; and yet another different instance on iCloud, each instance having potentially its own modifications and sharing settings.

In some embodiments, the control circuitry 200 and/or 228 may allow the user to control each separate instance of the video. For example, a new video file may be generated that includes the preexisting video and the video recording of the live scene in the preview of the camera. In this example, only the preexisting video may have been previously uploaded to multiple social media platforms, such as Facebook and Instagram. As such, when the new merged file that includes the preexisting video and the video recording of the live scene in the preview of the camera is generated, instead of having to re-upload the entire merged video file to both platforms, only an update to the Instagram instance may be performed. In other words, only the video instance residing on Instagram may be updated with the merged video file, while leaving the Facebook instance unmodified. Performing updates by instance may be beneficial to tailor content to specific audiences or maintain different versions of the same video across platforms.

In some embodiments, the electronic device may keep a record of where each video instance was uploaded, e.g., Facebook, Instagram, etc. Accordingly, when a user uploads morning videos to Facebook and evening videos to Instagram, the control circuitry 200 and/or 228 or the electronic device may keep a record of which platform each video instance is associated with. When a morning update or merged video may be performed, the control circuitry 200 and/or 228 may automatically, based on the user history of uploads in the morning to Facebook, update the Facebook instance and not the Instagram instance, since, based on the user history, the user usually uploads to Instagram in the evening.

In some embodiments, as depicted at 1230, the control circuitry 200 and/or 228 may assign privileges or permissions to the uploaded merged video that includes the preexisting video and the video recording of the live scene in the preview of the camera. In some embodiments, the preexisting video may have different viewing privileges/permissions than the uploaded merged video that includes the preexisting video and the video recording of the live scene in the preview of the camera. For example, a first set of viewers may be granted access to both the preexisting video, before any merging, and the merged video that includes the preexisting video and the video recording of the live scene in the preview of the camera, while a second set of viewers may be allowed to see only the added video recording of the live scene but not the preexisting video, or vice versa.

In some embodiments, the access privileges/permissions may be assigned by the control circuitry 200 and/or 228 based on a plurality of factors. These factors may include the relationship between the uploader and the viewer (e.g., friends, family, colleagues), the viewer's age, the time at which the video is being accessed, whether the access is public or private, and other preferences of both the sharer and the viewer. The uploader may also add additional factors that are to be considered in assigning privileges/permissions.

In some embodiments, the privileges/permissions may be stored in user settings, signaled during the upload, etc. There may not be a need to store the original preexisting video and the merged video in the database since access privileges/permissions may be granted based on byte ranges. For example, a byte offset associated with the new video, or any segment, maybe stored in a database and associated with user permission.

In some embodiments, user permissions may be tied to timestamps. In these embodiments, when a user requests access, the video player may dynamically reconfigure to limit playback to include or exclude footage with such timestamps (based on user permissions).

In some embodiments, the system may upload a preexisting video to a social media service, such as Facebook, Instagram, etc. After the preexisting video is uploaded to the social media service, a new video of the live scene being previewed by the camera may be generated and inserted at a determined insertion point in the preexisting video. The system may then update an instance of the first preexisting video with the new video that includes at least a portion of the live scene. The updating of the instance may include uploading the new video to the social media service. The system may also assign one or more permissions to the instance of the new inserted video uploaded to the social media service. These assigned permissions may specify terms and conditions of the authorized access criteria for a social media user to access the instance of the new inserted video uploaded to the social media service. As such, when a particular social media user wishes to consume the preexisting video with the inserted new video, a request may be sent to the system to determine whether to grant access to the new video. The system may receive the request by a particular social media user to consume the preexisting video with the inserted new video and in response may verify whether the particular social media user satisfies the assigned one or more permissions to the instance of the new inserted video to determine whether to grant access.

Based on the verification, the system may display a) only the preexisting video, b) both the preexisting video and the inserted new video, or c) only the inserted new video. In some embodiments, when a request is made and permission is not granted due to the social media user's permissions, a notification may be sent to the user that uploaded the new video, or the owner of the new video, that may provide them the option to allow or deny the request. A notification may also be provided to the requesting user that they have been denied access. In yet other embodiments, the new video may be hidden on the social media service and only displayed to users that have permissions. As such, users that do not qualify or have permissions may not even be shown the new inserted video but instead only the preexisting video. In some instances, the preexisting video and the new inserted video may have the same level of permissions. In such a scenario, if a social media user is permitted to consume the preexisting video, then may automatically also be permitted to consume the new inserted video.

In some embodiments, as depicted at 1240, the control circuitry 200 and/or 228 may share delta via a messaging application, where the delta is the video recording of the live scene in the preview of the camera. In this embodiment, a user may have shared the original preexisting video, which is unedited, via a messaging service (e.g., iMessage, WhatsApp, etc.). Subsequent to sharing the original unedited preexisting video, the control circuitry 200 and/or 228 may insert or append a video recording of the live scene in the preview, which is the delta, or insert or append a second preexisting video, into the original preexisting video and generate a single continuous video file. Since the original unedited preexisting video was already shared by the user, instead of having to share the generated single continuous video file, which includes both the original preexisting video and the video recording of the live scene in the preview, the control circuitry 200 and/or 228 may prompt the user to share the delta, which is only the video recording of the live scene in the preview. If the user accepts to share the delta, the recipient device may receive a message that provides a choice whether to accept a modification using the delta. If the recipient device accepts, then the integration of the newly recorded clip, which is video recording of the live scene in the preview, may be inserted into the previously shared original unedited preexisting video at the recipient device.

In some embodiments, the recipient device may auto-accept video modifications requests from their contacts, or designated contacts, etc. The recipient device may indicate this in their device setting or log in to a service and turn on auto-accept.

In some embodiments, the recipient device may use trust scores to determine whether to accept a modification request. These trust scores may be based on the recipient device's relationship with the sender of the modification or may be based on sender's public reputation, ratings, and other factors that reassure the user of the recipient device that the sender can be trusted, and the modification is not spam, a virus, or some other type of scam or fraudulent effort by a stranger. In some embodiments, when a modification request is presented to the recipient device, the recipient device, a server associated with the recipient device, or a service may automatically scan the delta, i.e., the new clip, for offensive content (e.g., nudity, violence, etc.). In some embodiments, automatically accepting the modification request may be based on a safety score or a genre of the newly recorded clip (or the preexisting video).

In some embodiments, as depicted at 1250, the control circuitry 200 and/or 228 may update an advertisement using the insertion and appending embodiments described herein. In these embodiments, an advertiser may want to update an existing ad (e.g., by adding frames with interactive buttons or banners to enable a user to purchase a product that may appear at any time during the ad runtime) without the need for any manual editing and re-uploading (e.g., to the ad server). In such embodiments, additional content may be identified as a supplement to an existing ad, such as a preexisting video, and can therefore be stitched into the ad video and shown to all viewers or a subset of viewers based on factors that include user demographics, preferences, and consumption history.

In some embodiments, an original ad may be already inserted in a media asset, or the ad by itself is the preexisting video. When the control circuitry 200 and/or 228 detects that an update to the ad is available, the control circuitry 200 and/or 228 may determine the insertion point for the update into the preexisting video. The control circuitry 200 and/or 228 may use techniques described in relation to FIGS. 6-8 to download or retrieve a portion of the content (original ad) and then use that as reference to insert or append the new update to generate a single continuous video that include the original ad and the new update.

In some embodiments, as depicted at 1260, the control circuitry 200 and/or 228 may add notes and audio to a preexisting video. In this embodiment, secondary items, such as voice notes, photos, text, graphics, artwork, icons, emojis, hyperlinks, and other information, may be added to a preexisting video.

In some embodiments, a user may use their user interface to add such secondary items to the preexisting video. When the user attempts to add such secondary items, the control circuitry 200 and/or 228 may automatically determine a logical, contextual insertion point in the preexisting video to add such secondary items. Similar factors as described herein may be used to identify the insertion point. For example, the control circuitry 200 and/or 228 may select an insertion point in the preexisting video based on continuity between a scene or audio in the preexisting video and the secondary content item.

In some embodiments, the control circuitry 200 and/or 228 may automatically provide suggestions to the user to embellish certain scenes or frames in the preexisting video with suggested secondary items. In some embodiments, the control circuitry 200 and/or 228 may, utilizing an AI engine, determine that speech relating to a particular segment or scene in the preexisting video needs further clarification and, thus, prompt the user to voice record a clarification that may then be inserted into the scene.

In other embodiments, the control circuitry 200 and/or 228 may recommend that voice notes be added to a video based on a voice signature. For example, a voice note sent through iMessage from a contact may result in prompting the user to “add” such voice note to a video associated with or featuring the contact. This may be based on audio analysis and voice signature matching.

In yet other embodiments, the control circuitry 200 and/or 228 may allow the user to add photos to preexisting videos (e.g., as a cover artwork), or even link photos to each other using photo IDs. This may result in presenting pictures from the photo library of the electronic device, or photos from the cloud, together in response to the user selecting one picture.

The control circuitry 200 and/or 228 may use techniques described in relation to FIGS. 6-8 to download I-frames or IDR frames of the preexisting videos and then use them as references to insert or append the secondary items to generate a single continuous video that includes the preexisting video and the secondary items.

It will be apparent to those of ordinary skill in the art that methods involved in the above-mentioned embodiments may be embodied in a computer program product that includes a computer-usable and/or-readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The features and processes discussed above may recite an I-frame or an IDR frame in certain embodiments. Although references may be made to an I-frame or IDR frame, the embodiments are not so limited, and any key frame may be used.

The processes discussed above are intended to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
detecting that a camera associated with an electronic device is previewing a live scene, wherein the live scene is within a field of view of the camera;
obtaining an attribute of the live scene;
querying a database having a plurality of preexisting videos to identify a preexisting video that includes an attribute that matches the obtained attribute of the live scene; and
in response to determining the attribute match:
selecting the identified preexisting video;
determining an insertion point in the preexisting video for inserting at least a portion of a new video that is to be recorded of the live scene;
recording the live scene to generate the new video; and
inserting the new video, which includes at least the portion of the live scene, at the determined insertion point to generate a single continuous video that includes both the preexisting video and the inserted new video.

2. The method of claim 1, further comprising, determining whether the determined insertion point is a) prior to a first frame of the preexisting video, b) in between the first frame and a last frame of the preexisting video, or c) after the last frame the preexisting video.

3. The method of claim 2, further comprising:
determining that the insertion point for the new video is in between the first frame and a last frame of the preexisting video; and
in response to determining that the insertion point for the new video is in between the first frame and a last frame of the preexisting video:
splitting the preexisting video into two segments, wherein the two segments include a pre-insertion segment and a post-insertion segment, and the pre-insertion segment includes content from the first frame of the preexisting video up to the insertion point, and the post-insertion segment includes content from the insertion point to the last frame of the preexisting video;
downloading, to the electronic device, a last key frame in the pre-insertion segment before the insertion point and a first key frame in the post-insertion segment after the insertion point; and
inserting the new video in between the two downloaded key frames.

4. The method of claim 3, wherein the last key frame in the pre-insertion segment before the insertion point and the first key frame in the post-insertion segment after the insertion point are I-frames and are contextually related.

5. (canceled)

6. The method of claim 2, further comprising:
determining that the insertion point for the new video is the last frame the preexisting video; and
in response to determining that the insertion point for the new video is after the last frame the preexisting video:
identifying a last key frame in the preexisting video before the insertion point; and
downloading to the electronic device the last key frame before the insertion point and content after the key frame leading up to the insertion point; and
appending the new video at the insertion point.

7-8. (canceled)

9. The method of claim 1, wherein obtaining the attribute from the live scene further comprises:
collecting a plurality of frames from the live scene;
buffering the collected plurality of frames from the live scene; and
analyzing the buffered plurality of collected frames to determine the attribute.

10. (canceled)

11. The method of claim 1, wherein selecting the preexisting video further comprises:
identifying a first and a second preexisting video, from the plurality of preexisting videos, both of which include an attribute that matches with the obtained attribute of the live scene; and
selecting the first preexisting video, from the identified first and second preexisting videos, based on the attribute of the first preexisting video having a higher degree of match with the attribute of the live scene than the attribute of the second preexisting video with the attribute of the live scene.

12. The method of claim 1, wherein the attribute used for the attribute match is related to a least one of a codec, resolution, frame rate, complexity of decoding frame, location, date range, time of day, object, people, animal, or a combination thereof.

13. The method of claim 1, further comprising:
determining that the preexisting video is uploaded to a social media service; and
updating an instance of the first preexisting video with the new video that includes at least a portion of the live scene, wherein updating the instance comprises uploading the new video to the social media service.

14. The method of claim 13, further comprising:
assigning one or more permissions to the instance of the new inserted video uploaded to the social media service, wherein the assigned permissions specify authorized access criteria for a social media user to access the instance of the new inserted video uploaded to the social media service;
receiving a request by a particular social media user to consume the preexisting video with the inserted new video; and
in response to receiving the request:
verifying whether the particular social media user satisfies the assigned one or more permissions to the instance of the new inserted video; and
displaying a) only the preexisting video, b) both the preexisting video and the new video in the single continuous video, or c) only the inserted new video based on the determined social media user's permissions.

15. A system comprising:
communications circuitry configured to access a live scene previewed by a camera associated with an electronic device; and
control circuitry configured to:
detecting that the camera is previewing a live scene, wherein the live scene is within a field of view of the camera;
obtain an attribute of the live scene;
query a database having a plurality of preexisting videos to identify a preexisting video that includes an attribute that matches the obtained attribute of the live scene; and
in response to determining the attribute match:
select the identified preexisting video;
determine an insertion point in the preexisting video for inserting at least a portion of a new video that is to be recorded of the live scene;
record the live scene to generate the new video; and
insert the new video, which includes at least the portion of the live scene, at the determined insertion point to generate a single continuous video that includes both the preexisting video and the inserted new video.

16. The system of claim 15, further comprising, the control circuitry configured to determine whether the determined insertion point is a) prior to a first frame of the preexisting video, b) in between the first frame and a last frame of the preexisting video, or c) after the last frame the preexisting video.

17. The system of claim 16, further comprising, the control circuitry configured to:
determine that the insertion point for the new video is in between the first frame and a last frame of the preexisting video; and
in response to determining that the insertion point for the new video is in between the first frame and a last frame of the preexisting video:
split the preexisting video into two segments, wherein the two segments include a pre-insertion segment and a post-insertion segment, and the pre-insertion segment includes content from the first frame of the preexisting video up to the insertion point, and the post-insertion segment includes content from the insertion point to the last frame of the preexisting video;
download, to the electronic device, a last key frame in the pre-insertion segment before the insertion point and a first key frame in the post-insertion segment after the insertion point; and
insert the new video in between the two downloaded key frames.

18. The system of claim 17, wherein the last key frame in the pre-insertion segment before the insertion point and the first key frame in the post-insertion segment after the insertion point are I-frames and are contextually related.

19. (canceled)

20. The system of claim 16, further comprising, the control circuitry configured to:
determine that the insertion point for the new video is the last frame the preexisting video; and
in response to determining that the insertion point for the new video is after the last frame the preexisting video:
identify a last key frame in the preexisting video before the insertion point; and
download to the electronic device the last key frame before the insertion point and content after the key frame leading up to the insertion point; and
append the new video at the insertion point.

21-22. (canceled)

23. The system of claim 15, wherein obtaining the attribute from the live scene further comprises, the control circuitry configured to:
collect a plurality of frames from the live scene;
buffer the collected plurality of frames from the live scene; and
analyze the buffered plurality of collected frames to determine the attribute.

24. (canceled)

25. The system of claim 15, wherein selecting the preexisting video further comprises, the control circuitry configured to:
identify a first and a second preexisting video, from the plurality of preexisting videos, both of which include an attribute that matches with the obtained attribute of the live scene; and
select the first preexisting video, from the identified first and second preexisting videos, based on the attribute of the first preexisting video having a higher degree of match with the attribute of the live scene than the attribute of the second preexisting video with the attribute of the live scene.

26. The system of claim 15, wherein the attribute used for the attribute match is related to a least one of a codec, resolution, frame rate, complexity of decoding frame, location, date range, time of day, object, people, animal, or a combination thereof.

27. The system of claim 15, further comprising, the control circuitry configured to:
determine that the preexisting video is uploaded to a social media service; and
update an instance of the first preexisting video with the new video that includes at least a portion of the live scene, wherein updating the instance comprises uploading the new video to the social media service.

28. The system of claim 27, further comprising, the control circuitry configured to:
assign one or more permissions to the instance of the new inserted video uploaded to the social media service, wherein the assigned permissions specify authorized access criteria for a social media user to access the instance of the new inserted video uploaded to the social media service;
receive a request by a particular social media user to consume the preexisting video with the inserted new video; and
in response to receiving the request:
verify whether the particular social media user satisfies the assigned one or more permissions to the instance of the new inserted video; and
display a) only the preexisting video, b) both the preexisting video and the new video in the single continuous video, or c) only the inserted new video based on the determined social media user's permissions.
